(19) United States
(12) Patent Application Publication
(10) Pub. No.: US 2017/0113407 A1
(43) Pub. Date: Apr. 27, 2017

(54) CROSSLINKABLE POLYCARBONATES FOR MATERIAL EXTRUSION ADDITIVE MANUFACTURING PROCESSES

(71) Applicant: SABIC GLOBAL TECHNOLOGIES B.V., Bergen op Zoom (NL)

(72) Inventors: Keith E. Cox, Mount Vernon, IN (US); Thomas Hocker, Pittsfield, MA (US); Jean-Francois Morizur, Mount Vernon, IN (US); Thomas L. Evans, Mount Vernon, IN (US); Amanda Marie Flores, Mount Vernon, IN (US); Peter Johnson, Mount Vernon, IN (US); Jeroen Visjager, Newburgh, IN (US); Malvika Bihari, Mount Vernon, IN (US)

(21) Appl. No.: 15/317,361

(22) PCT Filed: Jun. 16, 2015
(86) PCT No.: PCT/IB2015/054556

§ 371 Date: Dec. 8, 2016

Related U.S. Application Data
(60) Provisional application No. 62/012,858, filed on Jun. 16, 2014.

(51) Int. Cl. B29C 67/00; B33Y 70/00; B33Y 10/00

(52) U.S. Cl. CPC B29C 67/0055; B33Y 10/00; B33Y 70/00

(57) ABSTRACT

Methods of making articles using additive manufacturing processes are disclosed. The article is built up from a multitude of layers. At least one layer includes a modeling material comprising a cross-linkable polycarbonate resin containing a photoactive group derived from a benzophenone. When exposed to an effective dosage of ultraviolet radiation, the modeling material crosslinks. This improves various properties of the final article.

### CROSS-REFERENCE TO RELATED APPLICATIONS

This application claims priority to U.S. Provisional Patent Application Ser. No. 62/012,858, filed on Jun. 16, 2014, which is fully incorporated by reference herein.

### BACKGROUND

The present disclosure relates to methods of producing improved adhesion between layers of articles produced using additive manufacturing processes. Each layer is made from an extruded material that contains a cross-linkable polycarbonate resin containing a photoactive group derived from a benzophenone, which will crosslink upon exposure to ultraviolet radiation. Also included are the articles formed thereby, and methods of using such articles.

Additive Manufacturing (AM) is a new production technology that makes three-dimensional (3D) solid objects of virtually any shape from a digital model. Generally, this is achieved by creating a digital blueprint of a desired solid object with computer-aided design (CAD) modeling software and then slicing that virtual blueprint into very small digital cross-sections. These cross-sections are formed or deposited in a sequential layering process in an AM machine to create the 3D object. AM has many advantages, including dramatically reducing the time from design to prototyping to commercial product. Running design changes are possible. Multiple parts can be built in a single assembly. No tooling is required. Minimal energy is needed to make these 3D solid objects. It also decreases the amount of waste and raw materials. AM also facilitates production of extremely complex geometrical parts. AM also reduces the parts inventory for a business since parts can be quickly made on-demand and on-site.

Material Extrusion (a type of AM) can be used as a low capital forming process for producing polymeric parts, and/or a forming process for difficult geometries. Material Extrusion involves an extrusion-based additive manufacturing system that is used to build a three-dimensional (3D) model from a digital representation of the 3D model in a layer-by-layer manner by selectively dispensing a flowable material through a nozzle or orifice. After the material is extruded, it is then deposited as a sequence of roads on a substrate in an x-y plane. The extruded modeling material fuses to previously deposited modeling material, and solidifies upon a drop in temperature. The position of the extrusion head relative to the substrate is then incremented along a z-axis (perpendicular to the x-y plane), and the process is then repeated to form a 3D model resembling the digital representation.

Material Extrusion can be used to make final product parts, supports, and molds as well as to make prototype models for a wide variety of products. Part strength and appearance are secondary to overall design concept communication as improved aesthetic properties have been achieved by post process finishing steps such as coating or sanding. However, the strength of the parts in the build direction is limited by the bond strength and effective bonding surface area between subsequent layers of the build. These factors are limited for two reasons. First, each layer is a separate melt stream. Thus, the polymer chains of a new layer are not allowed to commingle with those of the antecedent layer. Secondly, because the previous layer has cooled, it must rely on conduction of heat from the new layer and any inherent cohesive properties of the material for bonding to occur. The reduced adhesion between layers also results in a highly stratified surface finish.

Accordingly, a need exists for enhanced AM processes capable of producing articles/parts with improved aesthetic qualities and structural properties.

### BRIEF DESCRIPTION

The present disclosure relates to methods for making articles using additive manufacturing (AM) processes that have enhanced properties, particularly improved chemical resistance and flame resistance. The articles are made by extruding a cross-linkable polycarbonate resin to form the layers of the article, then exposing the polycarbonate resin to ultraviolet radiation during or after forming to cause cross-linking.

Disclosed in various embodiments herein are methods of making an article, comprising: depositing one or more layers of extruded material in molten form in a preset pattern, wherein at least one layer is formed from a modeling material; and exposing the modeling material to an effective dosage of ultraviolet radiation to cause cross-linking in the article; wherein the modeling material is a polymeric composition that comprises a cross-linkable polycarbonate resin containing a photoactive group derived from a benzophenone. In other embodiments, the polymeric composition is one that comprises a cross-linkable polycarbonate resin containing a photoactive group.

Sometimes, the modeling material is continuously exposed to the ultraviolet radiation during the deposition thereof in molten form. In some embodiments, the deposition of the modeling material occurs in a chamber that is flooded with the ultraviolet radiation, such that the modeling material is continuously exposed to the ultraviolet radiation during deposition of each layer (“flood”). In other embodiments, a directed ultraviolet light source is used to expose a specific portion of the modeling material in molten form to ultraviolet radiation during the deposition thereof (“focus”).

In some embodiments, the modeling material is exposed to the ultraviolet radiation after the deposition of each layer is complete. The modeling material of the layer may still be in molten form during exposure to the ultraviolet radiation. Alternatively, the modeling material of the layer may have solidified prior to exposure to the ultraviolet radiation.

In yet other embodiments, the layers of the modeling material are exposed to the ultraviolet radiation in a specified pattern. In still different embodiments, the modeling material may be exposed to the ultraviolet radiation after the deposition of the multitude of layers is complete, either as the sole exposure or as a final post-cure after the layers have been previously exposed as described above. The UV dosage may be from about 0.025 J/cm² to about 21 J/cm² of UVA radiation.

In particular embodiments, the benzophenone from which the photoactive group is derived is a monohydroxybenzophenone. The cross-linkable polycarbonate resin can be formed from a reaction comprising: the monohydroxybenzophenone; a diol chain extender; and a first linker moiety comprising a plurality of linking groups, wherein each linking group can react with the hydroxyl groups of the monohydroxybenzophenone and the diol chain extender. The cross-linkable polycarbonate resin may contain from about 0.5 mol % to about 5 mol % of endcap groups derived from the monohydroxybenzophenone. More specifically, the monohydroxybenzophenone may be 4-hydroxybenzophenone

In other embodiments, the benzophenone from which the photoactive group is derived is a dihydroxybenzophenone. The cross-linkable polycarbonate resin can be formed from a reaction comprising: the dihydroxybenzophenone; a diol chain extender; a first linker moiety comprising a plurality of linking groups, wherein each linking group can react with the hydroxyl groups of the dihydroxybenzophenone and the diol chain extender; and an endcapping agent. In specific embodiments, the dihydroxybenzophenone is 4,4′-dihydroxybenzophenone; the diol chain extender is bisphenol-A; and the first linker moiety is phosgene. The end-capping agent can be selected from the group consisting of phenol, p-t-butylphenol, p-cumylphenol, octylphenol, and p-cyanophenol. The cross-linkable polycarbonate resin may contain from about 0.5 mol % to about 50 mol % of repeating units derived from the dihydroxybenzophenone.

In various embodiments, the modeling material is exposed to from about 0.025 J/cm² to about 21 J/cm² of UVA radiation. In other embodiments, the modeling material is exposed to ultraviolet radiation having a wavelength between 280 nm and 380 nm.

In particular embodiments, each layer of the article is formed from the modeling material. In others, at least one layer is formed from an extruded material that is different from the modeling material.

The articles formed by the methods described herein are also disclosed. The articles can have a storage modulus of about 400 MPa to about 1,600 MPa as measured by ASTM D5023-07.

These and other non-limiting characteristics are more particularly described below.

### BRIEF DESCRIPTION OF THE DRAWINGS

The following drawings are presented to illustrate the exemplary embodiments disclosed herein and not to limit them.

FIG. 1 illustrates the formation of a cross-linkable polycarbonate resin (oligomer/polymer) from a dihydroxybenzophenone (4,4′-dihydroxybenzophenone), a first linker moiety (phosgene), a diol chain extender (bisphenol-A), and an end-capping agent (p-cumylphenol).

FIG. 2 illustrates the formation of a branched cross-linkable polycarbonate (oligomer/polymer) from a dihydroxybenzophenone (4,4′-dihydroxybenzophenone), a first linker moiety (phosgene), a diol chain extender (bisphenol-A), an end-capping agent (p-cumylphenol), and a secondary linker moiety (1,1,1-tris-hydroxyphenylethane (THPE)).

FIG. 3 illustrates the formation of a cross-linkable polycarbonate (oligomer/polymer) from a monohydroxybenzophenone (4-hydroxybenzophenone), a first linker moiety (phosgene), and a diol chain extender (bisphenol-A).

FIG. 4 illustrates the formation of a cross-linkable polycarbonate (oligomer/polymer) from a monohydroxybenzophenone (4-hydroxybenzophenone), a first linker moiety (phosgene), a diol chain extender (bisphenol-A), and an additional endcapping agent (p-cumylphenol).

FIG. 5 illustrates the crosslinking mechanism of the cross-linkable polycarbonate.

### DETAILED DESCRIPTION

In the following specification, the examples, and the claims which follow, reference will be made to some terms which are defined as follows.

Unless otherwise defined, all technical and scientific terms used herein have the same meaning as commonly understood by one of ordinary skill in the art. In case of conflict, the present document, including definitions, will control. All publications, patent applications, patents and other references mentioned herein are incorporated by reference in their entirety.

The singular forms “a,” “an,” and “the” include plural referents unless the context clearly dictates otherwise.

As used in the specification and in the claims, the open-ended transitional phrases “comprise(s),” “include(s),” “having,” “contain(s),” and variants thereof require the presence of the named ingredients/steps and permit the presence of other ingredients/steps. These phrases should also be construed as disclosing the closed-ended phrases “consist of” or “consist essentially of” that permit only the named ingredients/steps and unavoidable impurities, and exclude other ingredients/steps.

Numerical values used herein should be understood to include numerical values which are the same when reduced to the same number of significant figures and numerical values which differ from the stated value by less than the experimental error of the measurement technique described for determining the value.

All ranges disclosed herein are inclusive of the recited endpoint and independently combinable (for example, the range of “from 2 grams to 10 grams” is inclusive of the endpoints, 2 grams and 10 grams, and all the intermediate values).

The term “about” can be used to include any numerical value that can carry without changing the basic function of that value. When used with a range, “about” also discloses the range defined by the absolute values of the two endpoints, e.g., “about 2 to about 4” also discloses the range “from 2 to 4.” The term “about” may refer to plus or minus 10% of the indicated number.

Compounds are described using standard nomenclature. Any position not substituted by an indicated group is understood to have its valency filled by a bond or a hydrogen atom. A dash (“-”) that is not between two letters indicates a point of attachment for a substituent, e.g. —CHO attaches through the carbon atom.

The term “aliphatic” refers to an array of atoms that is not aromatic. The backbone of an aliphatic group is composed exclusively of carbon. An aliphatic group is substituted or unsubstituted. Exemplary aliphatic groups are ethyl and isopropyl.

An “aromatic” radical has a ring system containing a delocalized conjugated pi system with a number of pi-electrons that obeys Hückel's Rule. The ring system may include heteroatoms (e.g. N, S, Se, Si, O), or may be composed exclusively of carbon and hydrogen. Aromatic groups are not substituted. Exemplary aromatic groups include phenyl, thienyl, naphthyl, and biphenyl.

An “ester” radical has the formula —CO—O—, with the carbon atom and the oxygen atom both bonded to carbon atoms. A “carbonate” radical has the formula —O—CO—O—, with the oxygen atoms both bonded to carbon atoms. Note that a carbonate group is not an ester group, and an ester group is not a carbonate group.

A “hydroxyl” radical has the formula —OH, with the oxygen atom bonded to a carbon atom. A “carboxy” or “carboxyl” radical has the formula —COOH, with the carbon atom bonded to another carbon atom. A carboxyl group can be considered as having a hydroxyl group. However, please note that a carboxyl group participates in certain reactions differently from a hydroxyl group. An “anhydride” radical has the formula —CO—O—CO—, with the carbonyl carbon atoms bonded to other carbon atoms. This radical can be considered equivalent to two carboxyl groups. The term “acid halide” refers to a radical of the formula —CO—X, with the carbon atom bonded to another carbon atom.

The term “alkyl” refers to a fully saturated radical composed entirely of carbon atoms and hydrogen atoms. The alkyl radical may be linear, branched, or cyclic. The term “aryl” refers to an aromatic radical composed exclusively of carbon and hydrogen. Exemplary aryl groups include phenyl, naphthyl, and biphenyl. The term “hydrocarbon” refers to a radical which is composed exclusively of carbon and hydrogen. Both alkyl and aryl groups are considered hydrocarbon groups. The term “heteroaryl” refers to an aromatic radical containing at least one heteroatom. Note that “heteroaryl” is a subset of aromatic, and is exclusive of “aryl”.

The term “halogen” refers to fluorine, chlorine, bromine, and iodine. The term “halo” means that the substituent to which the prefix is attached is substituted with one or more independently selected halogen radicals.

The term “alkoxy” refers to an alkyl radical which is attached to an oxygen atom, i.e. —O—CₙH₂ₙ₊₁. The term “aryloxy” refers to an aryl radical which is attached to an oxygen atom, e.g. —O—C₆H₅.

An “alkenyl” radical is composed entirely of carbon atoms and hydrogen atoms and contains a carbon-carbon double bond that is not part of an aromatic structure. An exemplary alkenyl radical is vinyl (—CH═CH₂).

The term “alkenyloxy” refers to an alkenyl radical which is attached to an oxygen atom, e.g. —O—CH═CH₂. The term “arylalkyl” refers to an aryl radical which is attached to an alkyl radical, e.g. benzyl (—CH₂—C₆H₅). The term “alkylaryl” refers to an alkyl radical which is attached to an aryl radical, e.g. tolyl (—C₆H₄—CH₃).

The term “substituted” refers to at least one hydrogen atom on the named radical being substituted with another functional group, such as halogen, —CN, or —NO₂. However, the functional group is not hydroxyl, carboxyl, ester, acid halide, or anhydride. Besides the aforementioned functional groups, an aryl group may also be substituted with alkyl or alkoxy. An exemplary substituted aryl group is methylphenyl.

The term “copolymer” refers to a polymer derived from two or more structural units or monomeric species, as opposed to a homopolymer, which is derived from only one structural unit or monomer. The term “dipolymer” refers to copolymers derived from only two different monomers, and the term “terpolymer” refers to copolymers derived from only three different monomers

The terms “Glass Transition Temperature” or “Tg” refer to the maximum temperature that a polycarbonate will retain at least one useful property such as impact resistance, stiffness, strength, or shape retention. The Tg can be determined by differential scanning calorimetry.

“Polycarbonate” as used herein refers to an oligomer or a polymer comprising residues of one or more monomers, joined by carbonate linkages.

The terms “UVA”, “UVB”, “UVC”, and “UVV” as used herein were defined by the wavelengths of light measured with the radiometer (EIT PowerPuck II) used in these studies, as defined by the manufacturer (EIT Inc., Sterling, Va.). “UV” radiation refers to wavelengths of 200 nm to 450 nm. UVA refers to the range from 320-390 nm, UVB to the range from 280-320 nm, UVC to the range from 250-260 nm, and UVV to the range from 395-445 nm.

The term “crosslink” and its variants refer to the formation of a stable covalent bond between two polymers/oligomers. This term is intended to encompass the formation of covalent bonds that result in network formation, or the formation of covalent bonds that result in chain extension. The term “cross-linkable” refers to the ability of a polymer/oligomer to form such stable covalent bonds.

The present disclosure refers to “polymers,” “oligomers”, and “compounds”. A polymer is a large molecule composed of multiple repeating units chained together. Different molecules of a polymer will have different lengths, and so a polymer has a molecular weight that is based on the average value of the molecules (e.g. weight average or number average molecular weight). An “oligomer” has only a few repeating units, while a “polymer” has many repeating units. In this disclosure, “oligomer” refers to molecules having a weight average molecular weight (Mw) of less than 15,000, and the term “polymer” refers to molecules having an Mw of 15,000 or more, as measured by GPC using polycarbonate molecular weight standards, measured prior to any UV exposure. In a compound, all molecules have the same molecular weight.

The term “material extrusion additive manufacturing technique” as used in the specification and claims means that the article of manufacture can be made by any additive manufacturing technique that makes a three-dimensional solid object of any shape from a digital model by laying down material in layers from a thermoplastic material such as a string of pellets or a filament, by selectively dispensing the material through a nozzle or orifice. For example, the article can be made by laying down a plastic filament or string of pellets that is unwound from a coil or is deposited from an extrusion head. These additive manufacturing techniques include fused deposition modeling and fused filament fabrication as well as other material extrusion technologies as defined by ASTM F2792-12a.

The term “Material Extrusion” involves building a part or article layer-by-layer by heating thermoplastic material to a semi-liquid state and extruding it according to computer-controlled paths. Material extrusion can use a modeling material with or without a support material. The modeling material is used to produce the finished piece, and the support material is used to produce scaffolding that can be mechanically removed, washed away or dissolved when the process is complete. The process involves depositing material to complete each layer before the base moves down the Z-axis and the next layer begins. This process was originally described in U.S. Pat. No. 5,121,329.

The term “molten” refers to either a temperature setting or a material state where the polymer exhibits viscous flow under strain. For an amorphous polymer/oligomer, this is generally considered to be above the glass transition temperature. For a semi-crystalline polymer/oligomer, this is generally considered to be above the melting point temperature of the crystalline phase.

As used herein, “layer” is a term of convenience that includes any shape, regular or irregular, having at least a predetermined thickness. In some embodiments, the size and configuration of two dimensions are predetermined, and on some embodiments, the size and shape of all three dimensions of the layer is predetermined. The thickness of each layer can vary widely depending on the additive manufacturing method. In some embodiments, the thickness of each layer as formed differs from a previous or subsequent layer. In some embodiments, the thickness of each layer is the same. In some embodiments the thickness of each layer as formed is 10 micrometers (μm) to 5 millimeters (mm).

The term “storage modulus” refers to a measurement of elastic modulus calculated from dynamic mechanical temperature analysis. This can be measured by three point bending (flexure) according to ASTM D5023-2007.

As used herein, the date of the test standard is provided as the revision and the date, or a dash and the date, for example, ASTM D1003-07 is equivalent to ASTM D1003-Rev. 2007 is equivalent to ASTM D1003-2007.

The present disclosure relates to methods for making articles using an additive manufacturing (AM) process that extrudes a modeling material in layers to build the desired article. The modeling material includes a photoactive additive in the form of a cross-linkable polycarbonate resin, which can be used alone or blended with another polymeric base resin. When exposed to the appropriate wavelength of light, cross-linking occurs between the different layers of the article. This should improve adhesion between the layers, translating to improved part performance in tensile and flex properties. In addition, the resulting article will have improved anti-drip and flame retardant properties, e.g. chemical resistance, propensity to drip during burning, or the propensity to form a hole when exposed to a flame. In addition, the scratch and mar may be improved. The AM processes described herein can be used to provide thin-walled materials that are UL94 5VA compliant and highly transparent.

Generally, the methods of the present disclosure are based on the extrusion of a modeling material that includes a photoactive additive, which can be blended with another polymeric resin.

Generally, the photoactive additives (PAA) of the present disclosure are cross-linkable polycarbonate resins that contain photoactive ketone groups. The term “photoactive” refers to a moiety that, when exposed to ultraviolet light of the appropriate wavelength, crosslinks with another molecule. For example, the bisphenol-A monomer in a bisphenol-A homopolycarbonate is not considered to be photoactive, even though photo-Fries rearrangement can occur, because the atoms do not crosslink, but merely rearrange in the polymer backbone. A “ketone group” is a carbonyl group (—CO—) that is bonded to two other carbon atoms (i.e. —R—CO—R′—). An ester group and a carboxylic acid group are not a ketone group because their carbonyl group is bonded to an oxygen atom.

The photoactive additive is formed from a reaction mixture containing at least a benzophenone and a first linker moiety. The benzophenone has either one or two phenolic groups, and provides a photoactive ketone group for crosslinking. The first linker moiety comprises a plurality of functional groups that can react with the phenolic group(s) of the benzophenone. The reaction product of this mixture is the photoactive additive. Depending on whether the benzophenone is monofunctional or difunctional, an end-capping agent may also be included. As desired, a diol chain extender can also be included. The end-capping agent and the diol chain extender do not have photoactive properties.

In some embodiments, the benzophenone is a monohydroxybenzophenone, and has the structure of Formula (I):

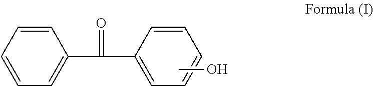

In more specific embodiments, the monohydroxybenzophenone is 4-hydroxybenzophenone (4-HBP).

In other embodiments, the benzophenone is a dihydroxybenzophenone, and has the structure of Formula (II):

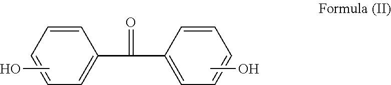

The two hydroxyl groups can be located in any combination of locations, e.g. 4,4′-; 2,2′-; 2,4′-; etc. In more specific embodiments, the dihydroxybenzophenone is 4,4′-dihydroxybenzophenone (4,4′-DHBP).

The photoactive hydroxybenzophenone is reacted with one or more first linker moieties. At least one of the first linker moieties comprises a plurality of functional groups that can react with the phenolic group of the photoactive benzophenones. Examples of such functional groups include a carboxylic acid (and anhydrides thereof), an acyl halide, an alkyl ester, and an aryl ester. These functional groups have the general formula —COY, wherein Y is hydroxyl, halogen, alkoxy, or aryloxy. The functional groups can be joined to an aliphatic group or an aromatic group which serves as a “backbone” for the linker moiety. In particular embodiments, the first linker moiety can have two, three, four, or even more functional groups. As a result, depending on its identity and on the other ingredients in the reaction, the first linker moiety can act as a branching agent.

Some examples of first linker moieties which have two functional groups and can react with the photoactive hydroxybenzophenones include those having the structure of one of formulas (1)-(4):

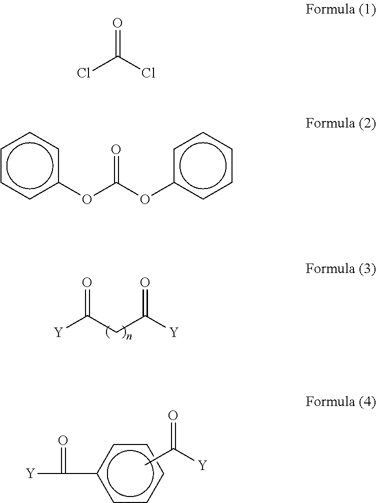

where Y is hydroxyl, halogen, alkoxy, or aryloxy; and where n is 1 to 20. It should be noted that Formula (3) encompasses adipic acid (n=4), sebacic acid (n=8), and dodecanedioic acid (n=10). Similarly, Formula (4) encompasses isophthalic acid and terephthalic acid. When diacids are used, the crosslinkable polycarbonate of the present disclosure may be a polyester-polycarbonate. The molar ratio of ester units to carbonate units in the polyester-polycarbonate may be 1:99 to 99:1, specifically 10:90 to 90:10, or 25:75 to 75:25.

Some examples of first linker moieties which have three functional groups and can react with the photoactive hydroxybenzophenones include those having the structure of one of the Formulas (5)-(7):

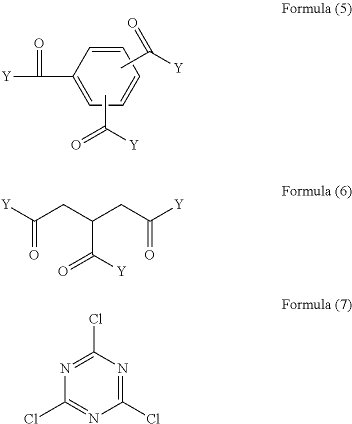

where Y is hydroxyl, halogen, alkoxy, or aryloxy.

Some examples of first linker moieties which have four functional groups and can react with the photoactive hydroxybenzophenones include those having the structure of one of Formulas (8)-(10):

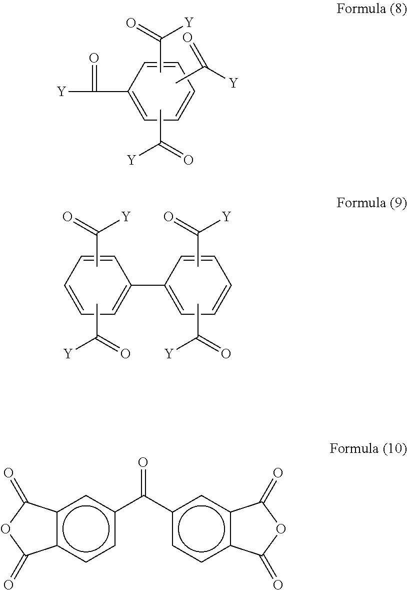

where Y is hydroxyl, halogen, alkoxy, or aryloxy.

In some embodiments, functional groups can be provided by short oligomers, including oligomers containing glycidyl methacrylate monomers with styrene or methacrylate monomers, or epoxidized novolac resins. These oligomers can permit the desired number of functional groups to be provided. Such oligomers are generalized by the structure of Formula (11):

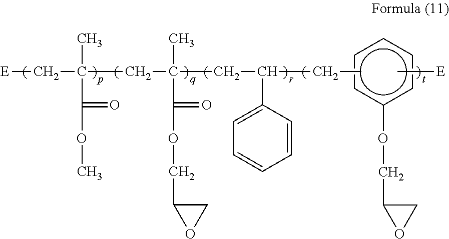

where E is hydrogen or an end-capping agent, p is the number of methacrylate monomers, q is the number of methacrylate monomers, r is the number of styrene monomers, and t is the number of epoxidized novolac (phenol-formaldehyde) monomers. Generally p+q+r+t≦20. When the oligomer contains glycidyl methacrylate monomers with styrene or methacrylate monomers, generally t=0 and q≧1. Similarly, for novolac resins, p=q=r=0. The epoxy groups can be reacted with the phenolic group of the photoactive benzophenone.

It is noted that using phosgene and diphenyl carbonate, Formulas (1) and (2) respectively, will result in the formation of carbonate linkages, while using the other first linker moieties will generally result in the formation of ester linkages. In particular embodiments, phosgene or diphenyl carbonate is used as the first linker moiety.

When the benzophenone is a monohydroxybenzophenone, the molar ratio of the benzophenone to the first linker moiety can be from 1:2 to 1:200 prior to UV exposure, including from about 1:10 to about 1:200 or from about 1:20 to about 1:200. When the benzophenone is a dihydroxybenzophenone, the molar ratio of the benzophenone to the first linker moiety can be from 1:1 to 1:200 prior to UV exposure, including from 1:2 to 1:200, or from about 1:99 to about 3:97, or from about 1:99 to about 6:94, or from about 10:90 to about 25:75 or from about 1:3 to about 1:200.

In particularly desired embodiments, the photoactive additive can be formed from a reaction mixture containing the photoactive benzophenone, the first linker moiety, and one or more diol chain extenders. The diol chain extender is a molecule that contains only two hydroxyl groups and is not photoactive when exposed to light. The chain extender can be used to provide a desired level of miscibility. The photoactive additive may comprise from about 75 mol % to about 99.5 mol %, or from 95 mol % to about 99 mol %, or from about 80 mol % to about 95 mol %, or from about 80 mol % to about 90 mol %, of the diol chain extender.

A first exemplary diol chain extender is a bisphenol of Formula (A):

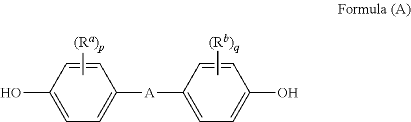

wherein R^{a} and R^{b} each represent a halogen atom or a monovalent hydrocarbon group and may be the same or different; p and q are each independently integers of 0 to 4; and A represents one of the groups of Formula (A-1):

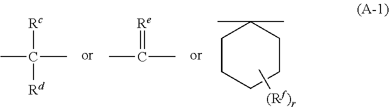

wherein R^{c} and R^{d} each independently represent a hydrogen atom or a monovalent linear or cyclic hydrocarbon group; R^{e} is a divalent hydrocarbon group; R^{f} is a monovalent linear hydrocarbon group; and r is an integer from 0 to 5. For example, A can be a substituted or unsubstituted C₃-C₁₈ cycloalkylidene.

Specific examples of the types of bisphenol compounds that may be represented by Formula (A) include 2,2-bis(4-hydroxyphenyl) propane (“bisphenol-A” or “BPA”), 4,4′-(1-phenylethane-1,1-diyl)diphenol or 1,1-bis(4-hydroxyphenyl)-1-phenylethane (bisphenol-AP); 1,1-bis(4-hydroxyphenyl)-3,3,5-trimethylcyclohexane) (bisphenol TMC); 1,1-bis(4-hydroxy-3-methylphenyl) cyclohexane (DMBPC); and 2,2-bis(3,5-dibromo-4-hydroxyphenyl) propane (tetrabromobisphenol-A or TBBPA).

A second exemplary diol chain extender is a bisphenol of Formula (B):

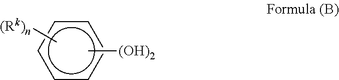

wherein each R^{k} is independently a C₁₋₁₀ hydrocarbon group, and n is 0 to 4. The halogen is usually bromine. Examples of compounds that may be represented by Formula (B) include resorcinol, 5-methyl resorcinol, 5-phenyl resorcinol, catechol; hydroquinone; and substituted hydroquinones such as 2-methyl hydroquinone.

A third exemplary diol chain extender is a bisphenolpolydiorganosiloxane of Formula (C-1) or (C-2):

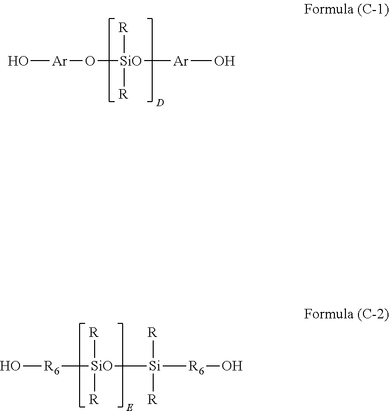

wherein each Ar is independently aryl; each R is independently alkyl, alkoxy, alkenyl, alkenyloxy, aryl, aryloxy, arylalkyl, or alkylaryl; each R₆ is independently a divalent C₁-C₃₀ organic group such as a C₁-C₃₀ alkyl, C₁-C₃₀ aryl, or C₁-C₃₀ alkylaryl; and D and E are an average value of 2 to about 1000, including from about 2 to about 500, or about 10 to about 200, or more specifically about 10 to about 75.

Specific examples of Formulas (C-1) and (C-2) are illustrated below as Formulas (C-a) through (C-d):

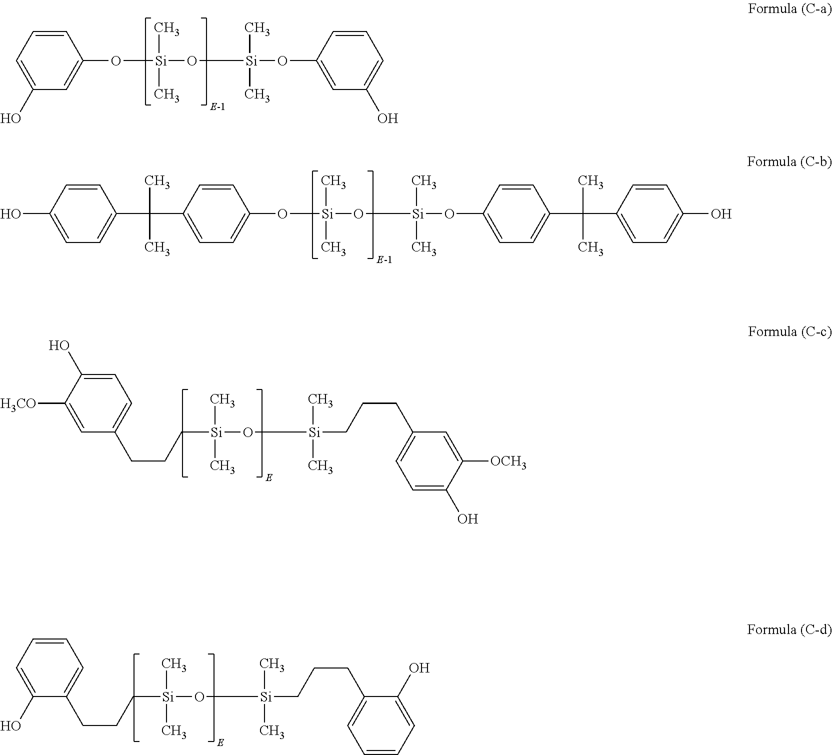

where E is an average value from 10 to 200.

A fourth exemplary diol chain extender is an aliphatic diol of Formula (D):

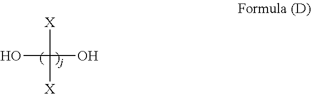

wherein each X is independently hydrogen, halogen, or alkyl; and j is an integer from 1 to 20. Examples of an aliphatic diol include ethylene glycol, propanediol, 2,2-dimethyl-propanediol, 1,6-hexanediol, and 1,12-dodecanediol.

A fifth exemplary diol chain extender is a dihydroxy compound of Formula (E), which may be useful for high heat applications:

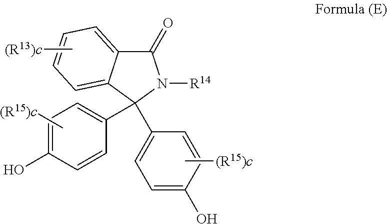

wherein R¹³ and R¹⁵ are each independently halogen or C₁-C₆ alkyl, R¹⁴ is C₁-C₆ alkyl, or phenyl substituted with up to five halogens or C₁-C₆ alkyl groups, and c is 0 to 4. In specific embodiments, R¹⁴ is a C₁-C₆ alkyl or phenyl group; or each c is 0. Compounds of Formula (E) include 3,3-bis(4-hydroxyphenyl)-2-phenylisoindolin-1-one (PPPBP).

Another dihydroxy chain extender that might impart high Tgs to the polycarbonate has adamantane units. Such compounds may have repetitive units of the following formula (F) for high heat applications:

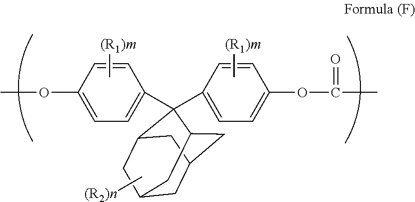

wherein R₁ is halogen, C₁-C₆ alkyl, C₁-C₆ alkoxy, C₆-C₁₂ aryl, C₇-C₁₃ aryl-substituted alkenyl, or C₁-C₆ fluoroalkyl; R₂ is halogen, C₁-C₁₂ alkyl, C₁-C₁₂ alkoxy, C₆-C₁₂ aryl, C₇-C₁₃ aryl-substituted alkenyl, or C₁-C₁₂ fluoroalkyl; m is an integer of 0 to 4; and n is an integer of 0 to 14.

Another dihydroxy compound that might impart high Tgs to the polycarbonate is a fluorene-unit containing dihydroxy compound represented by the following Formula (G):

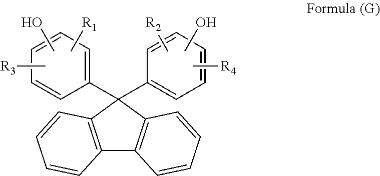

wherein R₁ to R₄ are each independently hydrogen, C₁-C₉ hydrocarbon, or halogen.

Another diol chain extender that could be used is an isosorbide. A monomer unit derived from isosorbide may be an isorbide-bisphenol unit of Formula (H):

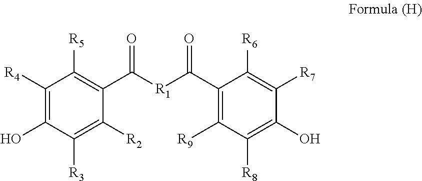

wherein R₁ is an isosorbide unit and R₂-R₉ are each independently a hydrogen, a halogen, a C₁-C₆ alkyl, a methoxy, an ethoxy, or an alkyl ester.

The R₁ isosorbide unit may be represented by Formula (H-a):

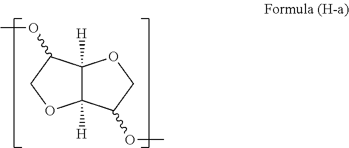

The isosorbide unit may be derived from one isosorbide, or be a mixture of isomers of isosorbide. The stereochemistry of Formula (I) is not particularly limited. These diols may be prepared by the dehydration of the corresponding hexitols. The isosorbide-bisphenol may have a pKa of between 8 and 11.

As previously explained, a photoactive hydroxybenzophenone is reacted with a first linker moiety to obtain the photoactive additive. In some embodiments, a secondary linker moiety is included in the reaction mixture. The secondary linker moiety has at least three functional groups, each of which can react with the functional groups of the first linker moiety, and acts as a branching agent. Generally, the functional groups of the secondary linker moiety are hydroxyl groups.

Some examples of secondary linker moieties which have three functional groups and can react with the first linker moiety include 1,1,1-trimethoxyethane; 1,1,1-trimethoxymethane; 1,1,1-tris (hydroxyphenyl) ethane (THPE), and 1,3,5-tris[2-(4-hydroxyphenyl)-propan-2-yl]benzene. Some examples of secondary linker moieties which have four functional groups and can react with the first linker moiety include pentaerythritol and 4-[2,6,6-tris(4-hydroxyphenyl)heptan-2-yl]phenol. In other embodiments, the secondary linker moiety can be an oligomer, made from epoxidized novolac monomer, that permits the desired number of functional groups to be provided.

An end-capping agent is generally used to terminate any polymer chains of the photoactive additive. The end-capping agent (i.e. chain stopper) can be a monohydroxy compound, a mono-acid compound, or a mono-ester compound. Exemplary endcapping agents include phenol, p-cumylphenol (PCP), resorcinol monobenzoate, p-tert-butylphenol, octylphenol, p-cyanophenol, and p-methoxyphenol. Unless modified with other adjectives, the term “end-capping agent” is used herein to denote a compound that is not photoactive when exposed to light. For example, the end-capping agent does not contain a ketone group. The photoactive additive may comprise about 0.5 mol % to about 5.0 mol % endcap groups derived from this non-photoactive end-capping agent. It is noted that when the cross-linkable polycarbonate resin contains a monohydroxybenzophenone, the monohydroxybenzophenone acts as an end-capping agent. In that situation, a second non-photoactive end-capping agent can also be used. The photoactive additive may comprise about 0.5 mol % to about 5.0 mol % endcap groups derived from each end-capping agent, including about 1 mol % to about 3 mol %, or from about 1.7 mol % to about 2.5 mol %, or from about 2 mol % to about 2.5 mol %, or from about 2.5 mol % to about 3.0 mol % endcap groups derived from each end-capping agent.

The photoactive additives of the present disclosure have photoactive groups that are derived from either a monohydroxybenzophenone or a dihydroxybenzophenone. When a monohydroxybenzophenone is used, the reaction mixture generally also includes a diol chain extender and a first linker moiety. The diol chain extender provides a monomer, and the monohydroxybenzophenone acts as an endcapping agent. The resulting additive can be considered a homopolymer. If desired, a secondary linker moiety can also be used. When a dihydroxybenzophenone is used, the reaction mixture generally also includes the first linker moiety, an endcapping agent, and a diol chain extender. The resulting additive can be considered a copolymer with the dihydroxybenzophenone and the diol chain extender acting as monomers. Photoactive additives having photoactive groups that are derived from both a monohydroxybenzophenone and a dihydroxybenzophenone are also contemplated.

The photoactive additives of the present disclosure can be a compound, an oligomer, or a polymer. The oligomer has a weight average molecular weight (Mw) of less than 15,000 Daltons (Da), including 10,000 Da or less. The polymeric photoactive additives of the present disclosure have a Mw of 15,000 or higher. In particular embodiments, the Mw is between 17,000 and 80,000 Da, or between 17,000 and 35,000 Da. These molecular weights are measured prior to any UV exposure. The Mw may be varied as desired. In some particular embodiments, the Mw of the photoactive additives is about 5,000 Da or less.

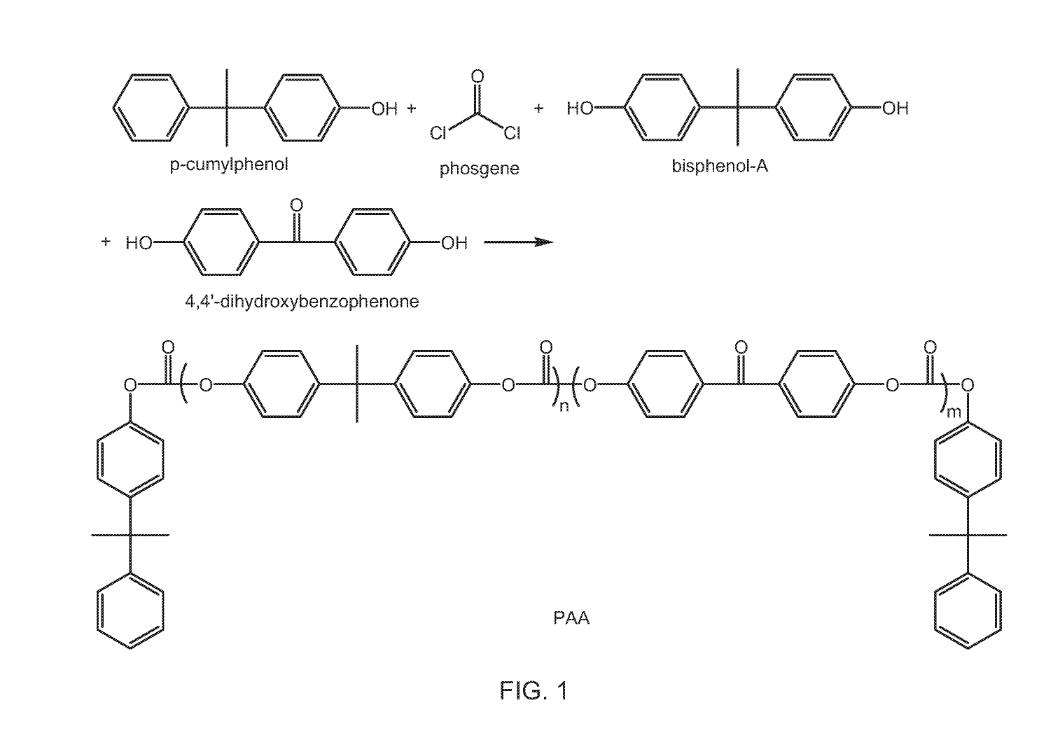

One example of a photoactive additive is a cross-linkable polycarbonate resin shown in FIG. 1. Here, 4,4′-dihydroxybenzophenone is reacted with phosgene (first linker moiety), bisphenol-A (diol chain extender), and p-cumylphenol (end-capping agent) to obtain the cross-linkable polycarbonate resin. A copolymer is thus formed with a weight average molecular weight and a polydispersity index, and containing carbonate linkages.

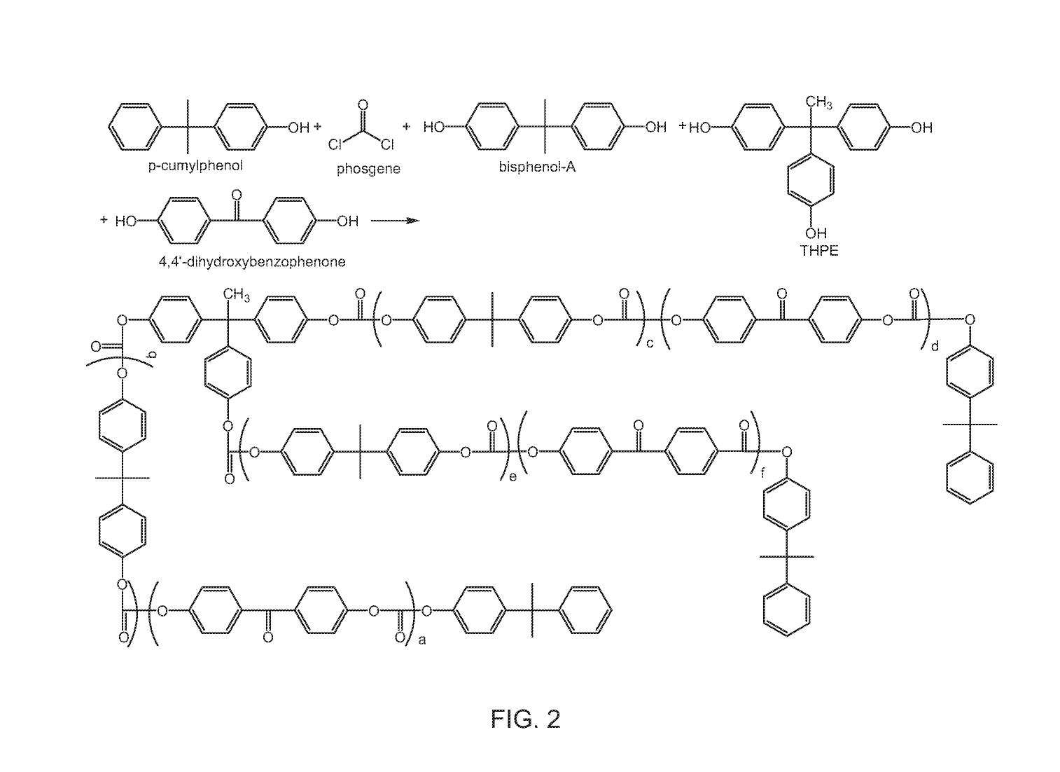

FIG. 2 illustrates the formation of a branched cross-linkable polycarbonate. Here, 4,4′-dihydroxybenzophenone is reacted with phosgene (first linker moiety), bisphenol-A (diol chain extender), p-cumylphenol (end-capping agent), and a secondary linker moiety (1,1,1-tris-hydroxyphenylethane (THPE)). A copolymer is thus formed.

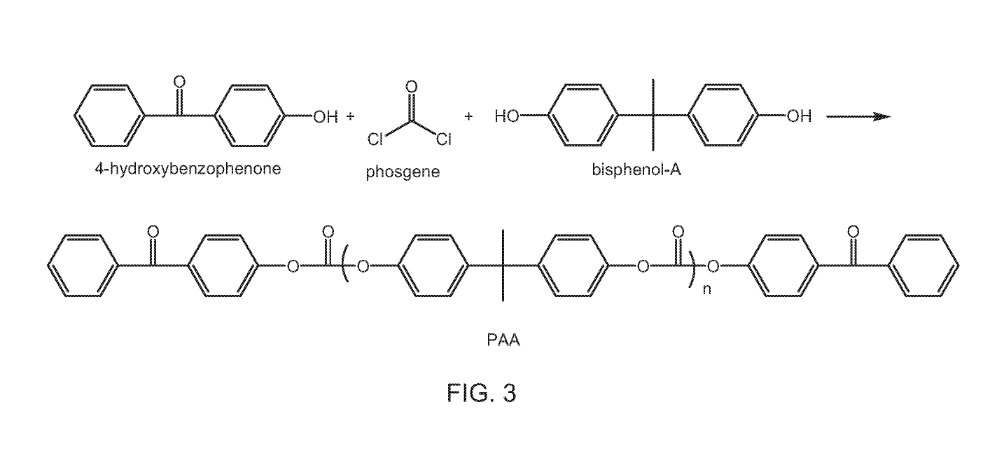

FIG. 3 illustrates the formation of another cross-linkable polycarbonate. Here, 4-hydroxybenzophenone is reacted with phosgene (first linker moiety), bisphenol-A (diol chain extender), and p-cumylphenol (end-capping agent) to obtain the cross-linkable polycarbonate resin.

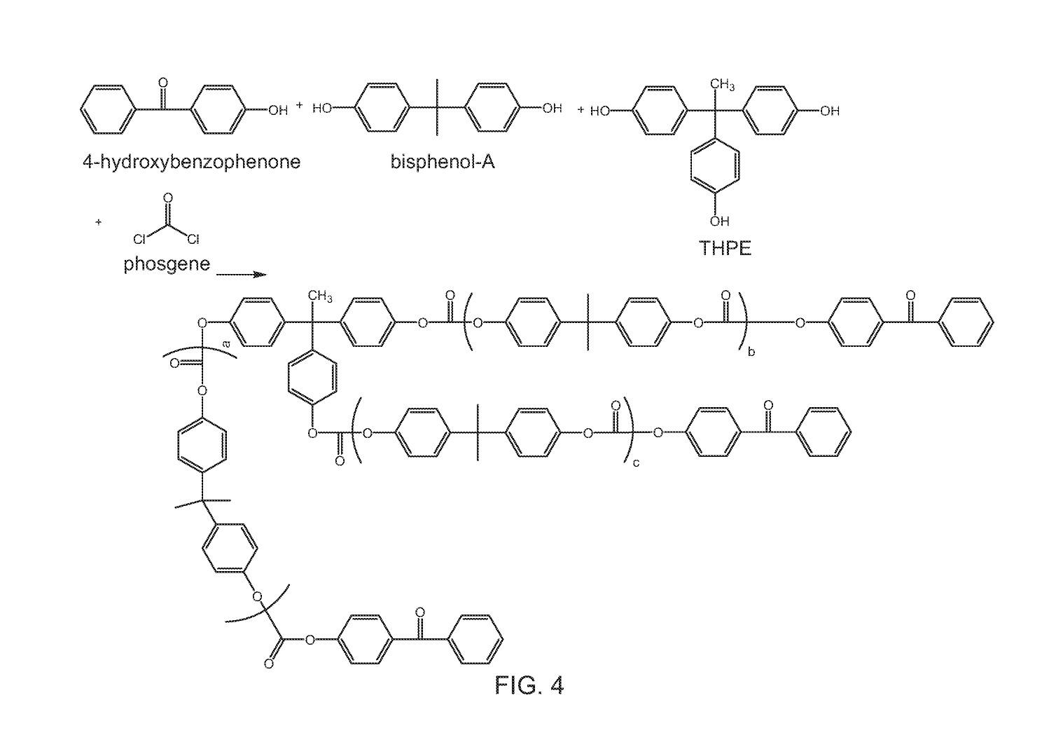

FIG. 4 illustrates the formation of a cross-linkable polycarbonate. Here, 4-hydroxybenzophenone is reacted with phosgene (first linker moiety), bisphenol-A (diol chain extender), p-cumylphenol (end-capping agent), and a secondary linker moiety (THPE).

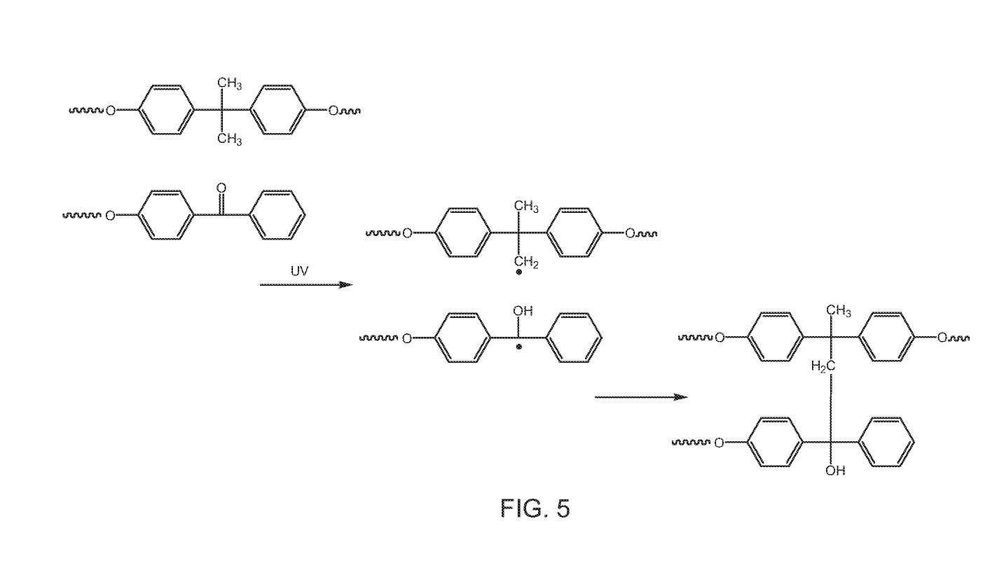

One crosslinking mechanism of the photoactive additives is believed to be due to hydrogen abstraction by the ketone group from an alkyl group that acts as a hydrogen donor and subsequent coupling of the resulting radicals. This mechanism is illustrated in FIG. 5 with reference to a benzophenone (the photoactive moiety) and a bisphenol-A (BPA) monomer. Upon exposure to UV, the oxygen atom of the benzophenone abstracts a hydrogen atom from a methyl group on the BPA monomer and becomes a hydroxyl group. The methylene group then forms a covalent bond with the carbon of the ketone group. Put another way, the ketone group of the benzophenone could be considered to be a photoactive group. It should be noted that the presence of hydrogen is critical for this reaction to occur. Other mechanisms may occur after the initial abstraction event with base resins containing unsaturated bonds or reactive side groups. It is noted that this crosslinking mechanism requires UV light exposure, and is not initiated by conventional extrusion or molding temperatures.

In some embodiments, the photoactive additive is a cross-linkable polycarbonate resin comprising repeating units derived from a dihydroxybenzophenone monomer (i.e. of Formula (II)). The cross-linkable polycarbonate resin may comprise from about 0.5 mol % to about 50 mol % of the dihydroxybenzophenone. In more particular embodiments, the cross-linkable polycarbonate resin comprises from about 1 mol % to about 3 mol %, or from about 1 mol % to about 5 mol %, or from about 1 mol % to about 6 mol %, or from about 5 mol % to about 20 mol %, or from about 10 mol % to about 20 mol %, or from about 0.5 mol % to about 25 mol % of the dihydroxybenzophenone. In more specific embodiments, the photoactive cross-linkable polycarbonate resin is a copolymer formed from the dihydroxybenzophenone, a diol chain extender, phosgene, and one or more end-capping agents. Most desirably, the dihydroxybenzophenone is 4,4′-dihydroxybenzophenone. Usually, the diol chain extender is bisphenol-A. In particular embodiments, the cross-linkable polycarbonate is a copolymer consisting of repeating units derived from 4,4′-dihydroxybenzophenone and bisphenol-A, with endcaps that are not photoactive. The copolymer contains from about 0.5 mol % to 50 mol % of the dihydroxybenzophenone, and from about 50 mol % to 99.5 mol % of the bisphenol-A.

In other embodiments, the photoactive additive is a cross-linkable polycarbonate resin comprising repeating units derived from a monohydroxybenzophenone monomer (i.e. of Formula (I)). The cross-linkable polycarbonate may comprise about 0.5 mol % to about 5 mol % endcap groups derived from the monohydroxybenzophenone, including from about 1 mol % to about 3 mole, or from about 1.7 mol % to about 2.5 mol %, or from about 2 mol % to about 2.5 mol %, or from about 2.5 mol % to about 3.0 mol %, or from about 3.5 mol % to about 4.0 mol % endcap groups derived from the monohydroxybenzophenone. In more specific embodiments, the photoactive cross-linkable polycarbonate resin is a homopolymer formed from the monohydroxybenzophenone, a diol chain extender, and phosgene. Most desirably, the dihydroxybenzophenone is 4-hydroxybenzophenone. Usually, the diol chain extender is bisphenol-A. In particular embodiments, the cross-linkable polycarbonate is a bisphenol-A homopolycarbonate consisting of repeating units derived from bisphenol-A, with the photoactive monohydroxybenzophenone endcaps.

In particular embodiments, the photoactive cross-linkable polycarbonate contains about 0.5 mole percent (mol %) of endcaps derived from a monohydroxybenzophenone, and has a weight-average molecular weight (Mw) from 17,000 to 30,000 Da. In other specific embodiments, the photoactive cross-linkable polycarbonate contains about 2.5 mol % of endcaps derived from a monohydroxybenzophenone, and has a weight-average molecular weight (Mw) from 24,000 to 31,000 Da. In still other definite embodiments, the photoactive cross-linkable polycarbonate has an MVR of 8 to 10 cc/10 min at 300° C./1.2 kg.

These polycarbonates, prior to cross-linking, can be provided as thermally stable high melt-flow polymers, and can thus be used to fabricate a variety of thin-walled articles (e.g., 3 mm or less). These articles are subsequently exposed to ultraviolet radiation to affect cross-linking. The cross-linked materials, in addition to flame resistance and chemical resistance, may retain or exhibit superior mechanical properties (e.g., impact resistance, ductility) as compared to the polycarbonate resin prior to cross-linking.

The cross-linkable polycarbonates of the present disclosure include homopolycarbonates, copolymers comprising different moieties in the carbonate (referred as “copolycarbonates”), copolymers comprising carbonate units and other types of polymer units such as polyester units, polysiloxane units, and combinations comprising at least one homopolycarbonate and copolycarbonate.

The cross-linkable polycarbonates of the present disclosure may have a glass transition temperature (Tg) of greater than 120° C., 125° C., 130° C., 135° C., 140° C., 145° C., 150° C., 155° C., 160° C., 165° C., 170° C., 175° C., 180° C., 185° C., 190° C., 200° C., 210° C., 220° C., 230° C., 240° C., 250° C., 260° C., 270° C., 280° C., 290° C., or 300° C., as measured using a differential scanning calorimetry method. In certain embodiments, the polycarbonates have glass transition temperatures ranging from about 120° C. to about 230° C., about 140° C. to about 160° C., about 145° C. to about 155° C., about 148° C. to about 152° C., or about 149° C. to about 151° C.

The cross-linkable polycarbonates of the present disclosure may have a weight average molecular weight (Mw) of 15,000 to about 80,000 Da [±1,000 Da], or of 15,000 to about 35,000 Da [±1,000 Da], or of about 20,000 to about 30,000 Da [±1,000 Da], or of 17,000 to about 80,000 Da. Molecular weight determinations may be performed using gel permeation chromatography (GPC), using a cross-linked styrene-divinylbenzene column and calibrated to polycarbonate references using a UV-VIS detector set at 264 nm, for example on an Agilent 1260 with a Waters Styragel HR5E Mixed Bed column (300×7.8 mm) using a 254 nm UV-detector. Samples may be prepared at a concentration of about 1 milligram per milliliter (mg/ml, and eluted at a flow rate of about 1.0 milliliters per minute (ml/min).

The cross-linkable polycarbonates of the present disclosure may have a polydispersity index (PDI) of about 2.0 to about 5.0, about 2.0 to about 3.0, or about 2.0 to about 2.5. The PDI is measured prior to any UV exposure.

It is noted that the molecular weight (both weight-average and number-average) of the cross-linkable polycarbonate can be measured using two different kinds of detectors. More specifically, the molecular weight can be measured using an ultraviolet (UV) detector or using a refractive index (RI) detector, using GPC and calibrated to polycarbonate standards for both detectors. In embodiments, the ratio of the polydispersity index (PDI) measured using a UV detector to the PDI measured using an RI detector is 1.4 or less, when using a GPC method and polycarbonate molecular weight standards. The ratio may also be 1.2 or less, or 1.1 or less.

The cross-linkable polycarbonates of the present disclosure may have a melt flow rate (MFR) of 1 to 45 grams/10 min, 6 to 15 grams/10 min, 6 to 8 grams/10 min, 6 to 12 grams/10 min, 2 to 30 grams/10 min, 5 to 30 grams/10 min, 8 to 12 grams/10 min, 8 to 10 grams/10 min, or 20 to 30 grams/10 min, using the ASTM D1238-2013 method, 1.2 kg load, 300° C. temperature, 360 second dwell.

The cross-linkable polycarbonates of the present disclosure may have a biocontent of 2 weight percent (wt %) to 90 wt %; 5 wt % to 25 wt %; 10 wt % to 30 wt %; 15 wt % to 35 wt %; 20 wt % to 40 wt %; 25 wt % to 45 wt %; 30 wt % to 50 wt %; 35 wt % to 55 wt %; 40 wt % to 60 wt %; 45 wt % to 65 wt %; 55 wt % to 70% wt %; 60 wt % to 75 wt %; 50 wt % to 80 wt %; or 50 wt % to 90 wt %. The biocontent may be measured according to ASTM D6866-Rev. 2010.

The cross-linkable polycarbonates of the present disclosure may have a modulus of elasticity of greater than or equal to (≧)2200 megapascals (MPa), ≧2310 MPa, ≧2320 MPa, ≧2330 MPa, ≧2340 MPa, ≧2350 MPa, ≧2360 MPa, ≧2370 MPa, ≧2380 MPa, ≧2390 MPa, ≧2400 MPa, ≧2420 MPa, ≧2440 MPa, ≧2460 MPa, ≧2480 MPa, ≧2500 MPa, or ≧2520 MPa as measured by ASTM D790-Rev. 2010 at 1.3 mm/min, 50 mm span.

In embodiments, the cross-linkable polycarbonates of the present disclosure may have a flexural modulus of 2,200 to 2,500, preferably 2,250 to 2,450, more preferably 2,300 to 2,400 MPa. In other embodiments, the cross-linkable polycarbonates of the present disclosure may have a flexural modulus of 2,300 to 2,600, preferably 2,400 to 2,600, more preferably 2,450 to 2,550 MPa. The flexural modulus is also measured by ASTM D790-Rev. 2010.

The cross-linkable polycarbonates of the present disclosure may have a tensile strength at break of greater than or equal to (≧) 60 megapascals (MPa), ≧61 MPa, ≧62 MPa, ≧63 MPa, ≧64 MPa, ≧65 MPa, ≧66 MPa, ≧67 MPa, ≧68 MPa, ≧69 MPa, ≧70 MPa, ≧71 MPa, ≧72 MPa, ≧73 MPa, ≧74 MPa, ≧75 MPa as measured by ASTM D638-Rev. 2010, Type I at 50 mm/min.

The cross-linkable polycarbonates of the present disclosure may possess a ductility of greater than or equal to (≧) 60%, ≧65%, ≧70%, ≧75%, ≧80%, ≧85%, ≧90%, ≧95%, or 100% in a notched izod test at −20° C., −15° C., −10° C., 0° C., 5° C., 10° C., 15° C., 20° C., 23° C., 25° C., 30° C., or 35° C. at a thickness of 3.2 mm according to ASTM D 256-Rev. 2010.

The cross-linkable polycarbonates of the present disclosure may have a notched Izod impact strength (NII) of ≧500 J/m, ≧550 J/m, ≧600 J/m, ≧650 J/m, ≧700 J/m, ≧750 J/m, ≧800 J/m, ≧850 J/m, ≧900 J/m, ≧950 J/m, or ≧1000 J/m, measured at 23° C. according to ASTM D 256-Rev. 2010.

The cross-linkable polycarbonates of the present disclosure may have a heat distortion temperature of greater than or equal to 110° C., 111° C., 112° C., 113° C., 114° C., 115° C., 116° C., 117° C., 118° C., 119° C., 120° C., 121° C., 122° C., 123° C., 124° C., 125° C., 126° C., 127° C., 128° C., 129° C., 130° C., 131° C., 132° C., 133° C., 134° C., 135° C., 136° C., 137° C., 138° C., 139° C., 140° C., 141° C., 142° C., 143° C., 144° C., 145° C., 146° C., 147° C., 148° C., 149° C., 150° C., 151° C., 152° C., 153° C., 154° C., 155° C., 156° C., 157° C., 158° C., 159° C., 160, 161° C., 162° C., 163° C., 164° C., 165° C., 166° C., 167° C., 168° C., 169° C., or 170° C., as measured according to ASTM D648-Rev. 2007 at 1.82 MPa, with 3.2 mm thick unannealed mm bar.

The cross-linkable polycarbonates of the present disclosure may have a percent haze value of less than or equal to (≦) 10.0%, ≦8.0%, ≦6.0%, ≦5.0%, ≦4.0%, ≦3.0%, ≦2.0%, ≦1.5%, ≦1.0%, or ≦0.5% as measured at a certain thickness according to ASTM D 1003-07. The polycarbonate haze may be measured at a 2.0, 2.2, 2.4, 2.54, 2.6, 2.8, 3.0, 3.2, 3.4, 3.6, 3.8, or a 4.0 millimeter thickness. The polycarbonate may be measured at a 0.125 inch thickness.

The polycarbonate may have a light transmittance greater than or equal to (≧) 50%, ≧60%, ≧65%, ≧70%, ≧75%, ≧80%, ≧85%, ≧90%, ≧95%, ≧96%, ≧97%, ≧98%, ≧99%, ≧99.1%, ≧99.2%, ≧99.3%, ≧99.4%, ≧99.5%, ≧99.6%, ≧99.7%, ≧99.8%, or ≧99.9%, as measured at certain thicknesses according to ASTM D 1003-Rev. 07. The polycarbonate transparency may be measured at a 2.0, 2.2, 2.4, 2.6, 2.8, 3.0, 3.2, 3.4, 3.6, 3.8, or a 4.0 millimeter thickness.

In certain embodiments, the cross-linkable polycarbonates of the present disclosure do not include soft block or soft aliphatic segments in the polycarbonate chain. For example, the following aliphatic soft segments that may be excluded from the cross-linkable polycarbonates of the present disclosure include aliphatic polyesters, aliphatic polyethers, aliphatic polythioeithers, aliphatic polyacetals, aliphatic polycarbonates, C—C linked polymers and polysiloxanes. The soft segments of aliphatic polyesters, aliphatic polyethers, aliphatic polythioeithers, aliphatic polyacetals, aliphatic polycarbonates may be characterized as having number average molecular weight (Mns) of greater than 600 Da (Da).

An interfacial polycondensation polymerization process for bisphenol-A (BPA) based polycarbonates can be used to prepare the cross-linkable polycarbonates of the present disclosure. Although the reaction conditions for interfacial polymerization can vary, an exemplary process generally involves dissolving or dispersing one or more dihydric phenol reactants (e.g. bisphenol-A) in water, adding the resulting mixture to a water-immiscible solvent medium, and contacting the reactants with a carbonate precursor (e.g. phosgene) in the presence of a catalyst (e.g. triethylamine, TEA).

Four different processes are disclosed herein for producing some embodiments of the photoactive additive which contain carbonate linkages. Each process includes the following ingredients: a diol chain extender, an end-capping agent, a carbonate precursor, a base, a tertiary amine catalyst, water, and a water-immiscible organic solvent, and optionally a branching agent. It should be noted that more than one of each ingredient can be used to produce the photoactive additive. Some information on each ingredient is first provided below.

A hydroxybenzophenone is present as the photoactive moiety, and can be present either as the end-capping agent (i.e. monohydroxybenzophenone) or as a diol (i.e. dihydroxybenzophenone). In the process descriptions below, reference will be made to diols, which should be construed as referring to the dihydroxybenzophenone and the diol chain extender when a dihydroxybenzophenone monomer is used.

Reference will also be made to the end-capping agent, which should be construed as referring to the monohydroxybenzophenone when a monohydroxybenzophenone monomer is used.

The diol chain extender may have the structure of any one of Formulas (A)-(H), and include monomers such as bisphenol-A.

Examples of end-capping agents (other than the monohydroxybenzophenone) include phenol, p-cumylphenol (PCP), p-tert-butylphenol, octylphenol, and p-cyanophenol.

The carbonate precursor may be, for example, a carbonyl halide such as carbonyl dibromide or carbonyl dichloride (also known as phosgene), or a haloformate such as a bishaloformate of a dihydric phenol (e.g., the bischloroformate of bisphenol-A, hydroquinone, or the like) or a glycol (e.g., the bishaloformate of ethylene glycol, neopentyl glycol, polyethylene glycol, or the like). Combinations comprising at least one of the foregoing types of carbonate precursors can also be used. In certain embodiments, the carbonate precursor is phosgene, a triphosgene, diacyl halide, dihaloformate, dicyanate, diester, diepoxy, diarylcarbonate, dianhydride, diacid chloride, or any combination thereof. An interfacial polymerization reaction to form carbonate linkages may use phosgene as a carbonate precursor, and is referred to as a phosgenation reaction. Many such carbonate precursors correspond to a structure of Formulas (1) or (2).

The base is used for the regulation of the pH of the reaction mixture. In particular embodiments, the base is an alkali metal hydroxide, such as sodium hydroxide (NaOH) or potassium hydroxide (KOH).

A tertiary amine catalyst is used for polymerization. Exemplary tertiary amine catalysts that can be used are aliphatic tertiary amines such as triethylamine (TEA)), N-ethylpiperidine, 1,4-diazabicyclo[2.2.2]octane (DABCO), tributylamine, cycloaliphatic amines such as N,N-diethyl-cyclohexylamine and aromatic tertiary amines such as N,N-dimethylaniline.

Sometimes, a phase transfer catalyst is also used. Among the phase transfer catalysts that can be used are catalysts of the formula (R³⁰)₄Q⁺X, wherein each R³⁰ is the same or different, and is a C₁-C₁₀ alkyl group; Q is a nitrogen or phosphorus atom; and X is a halogen atom, C₁-C₈ alkoxy group, or C₆-C₁₈ aryloxy group. Exemplary phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁-C₈ alkoxy group or a C₆-C₁₈ aryloxy group, such as methyltributylammonium chloride.

The most commonly used water-immiscible solvents include methylene chloride, 1,2-dichloroethane, chlorobenzene, toluene, and the like.

In the first process, sometimes referred to as the “upfront” process, the diol(s), end-capping agent, catalyst, water, and water-immiscible solvent are combined upfront in a vessel to form a reaction mixture. The reaction mixture is then exposed to the carbonate precursor, for example by phosgenation, while the base is co-added to regulate the pH, to obtain the photoactive additive.

The pH of the reaction mixture is usually from about 8.5 to about 10, and can be maintained by using a basic solution (e.g. aqueous NaOH). The reaction mixture is then charged with the carbonate precursor, which is usually phosgene. The carbonate precursor is added to the reaction mixture over a period of about 15 minutes to about 45 minutes. While the carbonate precursor is being added, the pH is also maintained in the range of about 8.5 to about 10, again by addition of a basic solution as needed. The cross-linkable polycarbonate is thus obtained, and is then isolated from the reaction mixture.

In the second process, also known as the “solution addition” process, the diol(s), tertiary amine catalyst, water, and water-immiscible solvent are combined in a vessel to form a reaction mixture. The total charge of the carbonate precursor is then added to this reaction mixture in the vessel over a total time period, while the base is co-added to regulate the pH. The carbonate precursor is first added to the reaction mixture along with the base to regulate the pH for a first time period. After the first time period ends, the end-capping agent is added in a controlled manner to the reaction mixture, also referred to as programmed addition. The addition of the end-capping agent occurs for a second time period after the first time period, rather than as a bolus at the beginning of the reaction (as in the upfront process). The carbonate precursor and the base are also added concurrently with the end-capping agent during the second time period. After the second time period ends, the remainder of the carbonate precursor continues uninterrupted for a third time period until the total charge is reached. The base is also co-added during the third time period to regulate the reaction pH. The pH of the reaction mixture is usually from about 8.5 to about 10, and can be maintained by using a basic solution (e.g. aqueous NaOH, made from the base). The end-capping agent is not added during either the first time period or the third time period. The photoactive additive is thus obtained. The main difference between the first and second processes is in the addition of the end-capping agent over time.

In the second process, the carbonate precursor is added to the reaction mixture over a total time period, which may be for example from about 15 minutes to about 45 minutes. The total time period is the duration needed to add the total charge of the carbonate precursor (measured either by weight or by moles) to the reaction mixture. It is contemplated that the carbonate precursor is added at a constant rate over the total time period. The carbonate precursor is first added to the reaction mixture along with the base to regulate the pH for a first time period, ranging from about 2 minutes to about 20 minutes. Then, during a second time period, the end-capping agent is added to the reaction mixture concurrently with the carbonate precursor and the base. It is contemplated that the end-capping agent is added at a constant rate during this second time period, which can range from about 1 minute to about 5 minutes. After the second time period ends, the remaining carbonate precursor is charged to the reaction mixture for a third time period, along with the base to regulate the reaction pH. The cross-linkable polycarbonate is thus obtained, and is then isolated from the reaction mixture.

The total time period for the reaction is the sum of the first time period, the second time period, and the third time period. In particular embodiments, the second time period in which the solution containing the end-capping agent is added to the reaction mixture begins at a point between 10% to about 40% of the total time period. Put another way, the first time period is 10% of the total time period.

For example, if 2400 grams of phosgene were to be added to a reaction mixture at a rate of 80 g/min, and 500 ml of a PCP solution were to be added to the reaction mixture at a rate of 500 ml/min after an initial charge of 240 grams of phosgene, then the total time period would be 30 minutes, the first time period would be three minutes, the second time period would be one minute, and the third period would be 26 minutes.

The third process is also referred to as a bis-chloroformate or chloroformate (BCF) process. Chloroformate oligomers are prepared by reacting the carbonate precursor, specifically phosgene, with the diol(s) in the absence of the tertiary amine catalyst, while the base is co-added to regulate the pH. The chloroformate oligomers can contain a mixture of monochloroformates, bischloroformates, and bisphenol terminated oligomers. After the chloroformate oligomers are generated, the phosgene can optionally be allowed to substantially condense or hydrolyze, then the end-capping agent is added to the chloroformate mixture. The reaction is allowed to proceed, and the tertiary amine catalyst is added to complete the reaction. The pH of the reaction mixture is usually from about 8.5 to about 10 prior to the addition of the phosgene. During the addition of the phosgene, the pH is maintained between about 6 and about 8, by using a basic solution (e.g. aqueous NaOH).

The fourth process uses a tubular reactor. In the tubular reactor, the end-capping agent is pre-reacted with the carbonate precursor (specifically phosgene) to form chloroformates. The water-immiscible solvent is used as a solvent in the tubular reactor. In a separate reactor, the diol(s), tertiary amine catalyst, water, and water-immiscible solvent are combined to form a reaction mixture. The chloroformates in the tubular reactor are then fed into the reactor over a first time period along with additional carbonate precursor to complete the reaction while the base is co-added to regulate the pH. During the addition of the chloroformates, the pH is maintained between about 8.5 and about 10, by using a basic solution (e.g. aqueous NaOH).

The resulting cross-linkable polycarbonate formed by any of these processes contains only a small amount of low-molecular-weight components. This can be measured in two different ways: the level of diarylcarbonates (DAC) and the lows percentage can be measured. Diarylcarbonates are formed by the reaction of two end-capping agents with phosgene, creating a small molecule. In embodiments, the resulting photoactive additive contains less than 1000 ppm of diarylcarbonates. The lows percentage is the percentage by weight of oligomeric chains having a molecular weight of less than 1000. In embodiments, the lows percentage is 2.0 wt % or less, including from about 1.0 wt % to 2.0 wt %. The DAC level and the lows percentage can be measured by high performance liquid chromatography (HPLC) or gel permeation chromatography (GPC). Also of note is that the resulting photoactive additive does not contain any residual pyridine, because pyridine is not used in the manufacture of the photoactive additive.

The photoactive additive can be blended with a polymeric base resin that is different from the photoactive additive, i.e. a second polymer resin, to form the polymeric compositions/blends of the present disclosure. More specifically, the second polymer resin does not contain photoactive groups. In embodiments, the weight ratio of the cross-linkable polycarbonate resin to the polymeric base resin is from 1:99 to 99:1. When the additive contains a monohydroxybenzophenone, the weight ratio of the cross-linkable polycarbonate resin to the polymeric base resin may be from about 50:50 to about 95:5. When the the additive contains a dihydroxybenzophenone, the weight ratio of the cross-linkable polycarbonate resin to the polymeric base resin may be from about 10:90 to about 85:15, or from about 25:75 to about 50:50. The polymeric base resin has, in specific embodiments, a weight-average molecular weight of about 21,000 Da or greater, including from about 21,000 to about 40,000 Da.

The cross-linkable polycarbonate resins are suitable for blending with polycarbonate homopolymers, polycarbonate copolymers, and polycarbonate blends. They are also suitable for blending with polyesters, polyarylates, polyestercarbonates, and polyetherimides.

The blends may comprise one or more distinct cross-linkable polycarbonates, as described herein, and/or one or more cross-linked polycarbonate(s). The blends also comprise one or more additional polymers. The blends may comprise additional components, such as one or more additives. In certain embodiments, a blend comprises a cross-linkable and/or cross-linked polycarbonate (Polymer A) and a second polymer (Polymer B), and optionally one or more additives. In another embodiment, a blend comprises a combination of a cross-linkable and/or cross-linked polycarbonate (Polymer A); and a second polycarbonate (Polymer B), wherein the second polycarbonate is different from the first polycarbonate.

The second polymer (Polymer B) may be any polymer different from the first polymer that is suitable for use in a blend composition. In certain embodiments, the second polymer may be a polyester, a polyestercarbonate, a bisphenol-A homopolycarbonate, a polycarbonate copolymer, a tetrabromo-bisphenol A polycarbonate copolymer, a polysiloxane-co-bisphenol-A polycarbonate, a polyesteramide, a polyimide, a polyetherimide, a polyamideimide, a polyether, a polyethersulfone, a polyepoxide, a polylactide, a polylactic acid (PLA), or any combination thereof.

In certain embodiments, the polymeric base resin may be a vinyl polymer, a rubber-modified graft copolymer, an acrylic polymer, polyacrylonitrile, a polystyrene, a polyolefin, a polyester, a polyesteramide, a polysiloxane, a polyurethane, a polyamide, a polyamideimide, a polysulfone, a polyepoxide, a polyether, a polyimide, a polyetherimide, a polyphenylene ether, a polyphenylene sulfide, a polyether ketone, a polyether ether ketone, an acrylonitrile-butadiene-styrene (ABS) resin, an acrylic-styrene-acrylonitrile (ASA) resin, a polyethersulfone, a polyphenylsulfone, a poly(alkenylaromatic) polymer, a polybutadiene, a polyacetal, a polycarbonate, a polyphenylene ether, an ethylene-vinyl acetate copolymer, a polyvinyl acetate, a liquid crystal polymer, an ethylene-tetrafluoroethylene copolymer, an aromatic polyester, a polyvinyl fluoride, a polyvinylidene fluoride, a polyvinylidene chloride, tetrafluoroethylene, a polylactide, a polylactic acid (PLA), a polycarbonate-polyorganosiloxane block copolymer, or a copolymer comprising: (i) an aromatic ester, (ii) an estercarbonate, and (iii) carbonate repeat units. The blend composition may comprise additional polymers (e.g. a third, fourth, fifth, sixth, etc., polymer).

In certain embodiments, the polymeric base resin may be a homopolycarbonate, a copolycarbonate, a polycarbonate-polysiloxane copolymer, a polyester-polycarbonate, or any combination thereof. In certain embodiments, the polymeric base resin is a p-cumyl phenol capped poly(isophthalate-terephthalate-resorcinol ester)-co-(bisphenol-A carbonate) copolymer. In certain embodiments, the polymeric base resin is a polycarbonate-polysiloxane copolymer.

The p-cumyl phenol capped poly(isophthalate-terephthalate-resorcinol ester)-co-(bisphenol-A carbonate) polymer or a polycarbonate-polysiloxane copolymer may have a polysiloxane content from 0.4 wt % to 25 wt %. In one preferred embodiment, the polymeric base resin is a p-cumylphenol capped poly(19 mol % isophthalate-terephthalate-resorcinol ester)-co-(75 mol % bisphenol-A carbonate)-co-(6 mol % resorcinol carbonate) copolymer (Mw=29,000 Da). In another preferred embodiment, the polymeric base resin is a p-cumylphenol capped poly(10 wt % isophthalate-terephthalate-resorcinol ester)-co-(87 wt % bisphenol-A carbonate)-co-(3 mol % resorcinol carbonate) copolymer (Mw=29,000 Da).

In another preferred embodiment, the polymeric base resin is a polycarbonate polysiloxane copolymer. The polycarbonate-polysiloxane copolymer may be a siloxane block co-polycarbonate comprising from about 6 wt % siloxane (±10%) to about 20 wt % siloxane (±10%) and having a siloxane chain length of 10 to 200. In another preferred embodiment, the polymeric base resin is a PC-siloxane copolymer with 20% siloxane segments by weight.

In another preferred embodiment, the polymeric base resin is a p-cumylphenol capped poly(65 mol % BPA carbonate)-co-(35 mol % 3,3-bis(4-hydroxyphenyl)-2-phenylisoindolin-1-one (PPPBP) carbonate) copolymer (Mw=25,000 Da).

In another preferred embodiment, the polymeric base resin is a polyphosphonate polymer, a polyphosphonate copolymer, or a poly(polyphosphonate)-co-(BPA carbonate) copolymer.

In yet other embodiments, the polymer resin in the blend is selected from the group consisting of a polycarbonate-polysiloxane copolymer; a polycarbonate resin having an aliphatic chain containing at least two carbon atoms as a repeating unit in the polymer backbone; a copolyester polymer; a bisphenol-A homopolycarbonate; a polystyrene polymer; a poly(methyl methacrylate) polymer; a thermoplastic polyester; a polybutylene terephthalate polymer; a methyl methacrylate-butadiene-styrene copolymer; an acrylonitrile-butadiene-styrene copolymer; a dimethyl bisphenol cyclohexane-co-bisphenol-A copolymer; a polyetherimide; a polyethersulfone; and a copolycarbonate of bisphenol-A and 1,1-bis(4-hydroxyphenyl)-3,3,5-trimethylcyclohexane) (BPTMC).

In particular embodiments, the polymer resin in the blend is a polycarbonate-polysiloxane (PC—Si) copolymer. The polycarbonate units of the copolymer are derived from dihydroxy compounds having the structures of any of the formulas described above, but particularly those of the chain extenders of Formulas (A) and (B). Some illustrative examples of suitable dihydroxy compounds include the following: 1,1-bis(4-hydroxyphenyl) methane, 1,1-bis(4-hydroxyphenyl) ethane, 2,2-bis(4-hydroxyphenyl) propane (hereinafter “bisphenol-A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, and 1,1-bis(4-hydroxy-t-butylphenyl) propane; resorcinol, substituted resorcinol compounds such as 5-methyl resorcinol, 5-phenyl resorcinol, or 5-cumyl resorcinol; catechol; hydroquinone; and substituted hydroquinones such as 2-methyl hydroquinone, 2-t-butyl hydroquinone, 2-phenyl hydroquinone, 2-cumyl hydroquinone, or 2,3,5,6-tetramethyl hydroquinone. Bisphenol-A is often part of the PC—Si copolymer.

The polymer resin (polymer B) in the blend can be a polycarbonate resin having an aliphatic chain containing at least two carbon atoms as a repeating unit in the polymer backbone. This resin can also be considered a “soft segment polycarbonate” (SSP) resin. Generally speaking, the SSP resin is a copolymer of an aromatic difunctional compound and an aliphatic difunctional compound. The aromatic difunctional compound may have the structure of, for example, any of Formulas (A)-(H), previously described as chain extenders above. In specific embodiments, the aromatic difunctional compound is a bisphenol of Formula (A). The aliphatic difunctional compound provides a long aliphatic chain in the backbone and may have the structure of Formula (D). Exemplary aliphatic diols that are useful in SSP resins include adipic acid (n=4), sebacic acid (n=8), and dodecanedioic acid (n=10). The SSP resin can be formed, for example by the phosgenation of bisphenol-A, sebacic acid, and p-cumyl phenol. The SSP resin contains carbonate linkages and ester linkages.

In this regard, it is believed that the cross-linking reaction rate of the cross-linkable polycarbonate resin and its yield are directly related to the hydrogen-to-ketone ratio of the polymeric blend. Thus, the higher the hydrogen-to-ketone ratio of the blend, the higher the rate of chain-extension reaction/crosslinking should be. Due to the presence of the hydrogen-rich SSP resin with its aliphatic blocks, the hydrogen-to-ketone ratio is relatively high. As a result, the crosslinking density and the resulting flame retardance and chemical resistance should be very good for this blend. In addition, the SSP resin has very good flow properties. It is believed that the blend should also have good flow, and should also retain its ductile properties even after crosslinking.

The polymer resin (polymer B) in the blend can be a bisphenol-A homopolycarbonate. Such resins are available, for example as LEXAN™ from SABIC Innovative Plastics.

The polymer resin (polymer B) in the blend can be a polystyrene polymer. Such polymers contain only polystyrene monomers. Thus, for example ABS and MBS should not be considered polystyrene polymers.

The polymer resin (polymer B) in the blend can be a thermoplastic polyester. An exemplary polyester is PCTG, which is a copolymer derived from the reaction of terephthalic acid, ethylene glycol, and cyclohexanedimethanol (CHDM). The PCTG copolymer can contain 40-90 mol % CHDM, with the terephthalic acid and the ethylene glycol making up the remaining 10-60 mol %.

The polymer resin (polymer B) in the blend can be a dimethyl bisphenol cyclohexane-co-bisphenol-A copolymer, i.e. a DMBPC-BPA copolymer. The DMBPC is usually from 20 mol % to 90 mol % of the copolymer, including 25 mol % to 60 mol %. The BPA is usually from 10 mol % to 80 mol % of the copolymer, including 40 mol % to 75 mol %. These resins have high scratch resistance.

Other conventional additives can also be added to the polymeric composition (e.g. an impact modifier, UV stabilizer, colorant, flame retardant, heat stabilizer, plasticizer, lubricant, mold release agent, filler, reinforcing agent, antioxidant agent, antistatic agent, blowing agent, or radiation stabilizer).

In preferred embodiments, the blend compositions disclosed herein comprise a flame-retardant, a flame retardant additive, and/or an impact modifier. The flame-retardant may be potassium perfluorobutane sulfonate (Rimar salt), potassium diphenyl sulfone-3-sulfonate (KSS), or a combination thereof.

Various types of flame retardants can be utilized as additives. This includes flame retardant salts such as alkali metal salts of perfluorinated C₁-C₁₆ alkyl sulfonates such as potassium perfluorobutane sulfonate (Rimar salt), potassium perfluoroctane sulfonate, tetraethylammonium perfluorohexane sulfonate, potassium diphenylsulfone sulfonate (KSS), and the like, sodium benzene sulfonate, sodium toluene sulfonate (NATS) and the like. Rimar salt and KSS and NATS, alone or in combination with other flame retardants, are particularly useful in the compositions disclosed herein. In certain embodiments, the flame retardant does not contain bromine or chlorine, i.e. is non-halogenated. Another useful class of flame retardant is the class of cyclic siloxanes having the general formula [(R)₂SiO]_{y} wherein R is a monovalent hydrocarbon or fluorinated hydrocarbon having from 1 to 18 carbon atoms and y is a number from 3 to 12. A particularly useful cyclic siloxane is octaphenylcyclotetrasiloxane.

Exemplary heat stabilizer additives include, for example, organophosphites such as triphenyl phosphite, tris-(2,6-dimethylphenyl)phosphite, tris-(mixed mono- and di-nonylphenyl)phosphite or the like; phosphonates such as dimethylbenzene phosphonate or the like; phosphates such as trimethyl phosphate, or the like; or combinations thereof. Heat stabilizers are generally used in amounts of 0.0001 to 1 part by weight, based on 100 parts by weight of the polymer component of the polymeric blend/composition.

Mold release agent (MRA) will allow the material to be removed quickly and effectively. Mold releases can reduce cycle times, defects, and browning of finished product. Exemplary MRAs include phthalic acid esters; di- or polyfunctional aromatic phosphates such as resorcinol tetraphenyl diphosphate (RDP), the bis(diphenyl) phosphate of hydroquinone and the bis(diphenyl) phosphate of bisphenol-A; pentaerythritol tetrastearate (PETS), and the like. Such materials are generally used in amounts of 0.001 to 1 part by weight, specifically 0.01 to 0.75 part by weight, more specifically 0.1 to 0.5 part by weight, based on 100 parts by weight of the polymer component of the polymeric blend/composition.

In particular embodiments, the polymeric blend/composition includes the cross-linkable polycarbonate resin, an optional polymeric base resin, a flame retardant; a heat stabilizer, and a mold release agent.

The polymeric compositions/blends described above can be used in material extrusion additive manufacturing (ME/AM) processes to produce three-dimensional articles. The polymeric compositions/blends are first processed into a form suitable for use with an AM machine. For example, they can be processed into consumable pellet strings or monofilaments or directly from pellets.

In more particular embodiments, the polymeric composition/blend is processed into the form of a monofilament having a length, an exterior surface, and a plurality of tracks on the exterior surface along at least a portion of the length. The tracks can be engaged by the teeth of a rotatable drive mechanism in an AM machine, such as one available from Stratasys, Inc and known as FORTUS™ 400mc. This system is described in U.S. Pat. No. 8,236,227, the entire disclosure of which is herein incorporated by reference. As described there, the consumable monofilament is fed by the rotatable drive mechanism to a liquefier, which melts the monofilament to obtain a molten modeling material. The molten modeling material can be extruded and deposited in a layer-by-layer manner to form the article.

The pellet string/monofilament can have any suitable geometry. In some embodiments, the monofilament has a substantially cylindrical geometry with an average diameter ranging from about 1.27 millimeters (about 0.050 inches) to about 3.0 millimeters (about 0.120 inches). Alternatively, the monofilament may have a substantially rectangular cross-sectional profile. The tracks on the exterior surface of the monofilament can be of any suitable shape, such as rectangular tracks, parabolic tracks, worm-type tracks, corrugated tracks, textured tracks, impressed file-type tracks, herringbone-type tracks, sprocket tracks, edge-facing tracks, or staggered tracks.

Generally, a multitude of layers of modeling material are deposited in a preset pattern. The modeling material contains the cross-linkable polycarbonate resin described above. The modeling material is then exposed to an effective dosage of ultraviolet radiation to cause cross-linking between the multitude of layers. This exposure increases adhesion between the layers, which should translate to improved tensile and flex properties, and enhanced flame retardance and chemical resistance. In describing the methods used herein, it may be helpful to first describe an exemplary extrusion-based AM system.

An exemplary extrusion-based additive manufacturing system includes a build chamber and supply sources. The build chamber comprises a build platform, a gantry, and at least one extrusion head. The build platform is generally a flat surface on which the layers of extruded material are deposited to build up the article, and moves along a vertical z-axis relative to the gantry based on signals provided from a computer-operated controller. The build platform may be heated, which can help to prevent warping. The gantry is a guide rail system that is desirably configured to move the extrusion head(s) in a horizontal x-y plane about the build chamber based on signals provided from the controller. The horizontal x-y plane is a plane defined by an x-axis and a y-axis where the x-axis, the y-axis, and the z-axis are orthogonal to each other. Alternatively, the build platform may be configured to move in the horizontal x-y plane and the extrusion head(s) may be configured to move along the z-axis. Other similar arrangements may also be used such that the build platform and the extrusion head(s) are moveable relative to each other. The build chamber can be enclosed by a housing, or the build chamber can be exposed to ambient conditions.

An extrusion head is used to extrude a particular material in a specified location, and multiple extrusion heads may be present in the AM system. Such materials can include a modeling material and a support material. The modeling material is the polymeric composition/blend including the cross-linkable polycarbonate resin, and is used to build the article. The support material is a material used to provide support to the modeling material so that the final desired shape of the article can be obtained. For example, the support material can be deposited in a lower layer to support overhanging molten modeling material that will be placed directly above the support material in an upper layer located upon the lower layer. Once the modeling material has hardened, the support material can be removed, for example by being washed away or dissolution. Alternatively, multiple modeling materials may be used. For example, the polymeric composition/blend including the cross-linkable polycarbonate resin could be extruded to form exterior surfaces or contours of the article, and a different polycarbonate resin could be extruded to form interior surfaces or contours of the article. The extrusion head(s) are generally mounted in fixed relation to each other, and move relative to the build platform via the gantry. Each extrusion head is also connected to a supply source for the material to be extruded by that particular head. Material is extruded from the extrusion head through a nozzle or orifice.

In the ME/AM processes of the present disclosure, a multitude of layers of modeling material are deposited in a preset pattern. The preset pattern for each layer is determined so that the combined layers form the desired article. Each layer is formed from the modeling material, which is extruded in a molten form that subsequently cools and solidifies. Generally, each layer is deposited upon or adjacent to another layer, so that there is some portion of modeling material in each layer that contacts a portion of modeling material in another layer. The thickness of each layer can range from about 10 micrometers (μm) to about 5 mm. Again, multiple modeling materials can be used, and it is contemplated that layers containing the cross-linkable polycarbonate resin can be combined with layers formed from other polymers, with their order of deposition being varied to achieve a desired combination of mechanical, physical, and aesthetic properties.

The pellet string/monofilament of modeling material is melted to obtain a molten material that can be extruded to form the article. The modeling material is usually heated above its glass transition temperature (Tg). In particular embodiments, the modeling material (containing the cross-linkable polycarbonate resin) is heated to a temperature of about 260° C. to about 320° C., or from about 280° C. to about 320° C., or from about 280° C. to about 300° C., to be extruded. In other embodiments, the modeling material is heated to a temperature at least 50° C. above its Tg. This provides sufficient heat energy for heat to be transferred to the previously-deposited layer so that the previously-deposited layer can partially melt and form bonds with the newly-deposited layer.

Once deposited in the desired pattern, crosslinking within the modeling material is initiated by exposure to ultraviolet (UV) light at an appropriate wavelength and in an appropriate dosage. This may form cross-layer bonds, which improves inter-layer adhesion, as well as the physical and mechanical properties of the article formed using the ME/AM process.

The UV exposure can come from any source of UV light such as, but not limited to, those lamps powered by microwave, HID lamps, and mercury vapor lamps, lasers, and UV light emitting diodes (LEDs). Light guides may be used to direct the UV radiation from a UV light source to a desired location. The exposure time will dependent on the application and color of the material, but will generally range from a few seconds to some hours. For example, commercial UV lamps are sold for UV curing from manufacturers such as Hereaus Noblelight Fusion UV. Examples of UV-emitting light bulbs include mercury bulbs (H bulbs), or metal halide doped mercury bulbs (D bulbs, H+ bulbs, and V bulbs). Other combinations of metal halides to create a UV light source are also contemplated. Exemplary light sources could be LED light sources which match the absorbance of the photoactive species. A 365 nm peak LED source would be exemplary, as would LED light sources with a peak wavelength at a wavelength in the range of 320 nm to 380 nm.

It may also be advantageous to use a UV light source where the harmful wavelengths (those that cause polymer degradation or excessive yellowing) are removed or not present. Equipment suppliers such as Heraeus Noblelight and Fusion UV provide lamps with various spectral distributions. The light can also be filtered to remove harmful or unwanted wavelengths of light. This can be done with optical filters that are used to selectively transmit or reject a wavelength or range of wavelengths. These filters are commercially available from a variety of companies such as Edmund Optics or Praezisions Glas & Optik GmbH. Bandpass filters are designed to transmit a portion of the spectrum, while rejecting all other wavelengths. Longpass edge filters are designed to transmit wavelengths greater than the cut-on wavelength of the filter. Shortpass edge filters are used to transmit wavelengths shorter than the cut-off wavelength of the filter. Schott and/or Praezisions Glas & Optik GmbH for example have the following long pass filters: WG225, WG280, WG295, WG305, WG320 which have cut-on wavelengths of ˜225, 280, 295, 305, and 320 nm, respectively. These filters can be used to screen out the harmful short wavelengths while transmitting the appropriate wavelengths for the crosslinking reaction.

In particular embodiments, the modeling material is exposed to a selected UV light range having wavelengths from about 280 nanometers (nm) to about 380 nm, or from about 345 nm to about 375 nm. The wavelengths in a “selected” light range have an internal transmittance of greater than 50%, with wavelengths outside of the range having an internal transmittance of less than 50%. The change in transmittance may occur over a range of 20 nm. Reference to a selected light range should not be construed as saying that all wavelengths within the range transmit at 100%, or that all wavelengths outside the range transmit at 0%.

In some embodiments, the UV radiation per layer is set to provide an effective dosage of at least 0.025 Joules per square centimeter (J/cm²) of UVA radiation and no detectable UVC radiation, as measured using an EIT PowerPuck II. In other more specific embodiments, the UV radiation per layer is filtered to provide an effective dosage of at least 0.07 J/cm² of UVA radiation and no detectable UVC radiation, including at least 0.1 J/cm² of UVA radiation and no detectable UVC radiation, or at least 0.2 J/cm² of UVA radiation and no detectable UVC radiation, or at least 0.4 J/cm² of UVA radiation and no detectable UVC radiation, as measured using an EIT PowerPuck II. In more particular embodiments, the effective dosage is from about 0.07 J/cm² to about 0.5 J/cm² of UVA radiation and no detectable UVC radiation. These dosages are per layer exposed; the total UV dosage for a given article will depend on the design of the article. In particular embodiments, a post-cure UV dosage (after formation of the article is complete) can be in the range of at least 2 J/cm² to about 21 J/cm² of UVA radiation.

The exposure of the modeling material to the UV radiation is contemplated as being provided in many different ways, some of which are described herein.

In a first set of embodiments, the modeling material is continuously exposed (“flooded”) to the UV radiation as it is deposited in molten form in the preset pattern of a given layer. This continuous exposure may be provided by flooding the build chamber with UV light to illuminate the entire build platform. As a result, as each layer of modeling material is deposited, the newly-deposited layer is exposed to UV radiation, along with all of the other previously-deposited layers. It is contemplated that in some embodiments, the UV light sources remain continuously “on” during the deposition of the modeling material until the article is completely built up. The UV light sources would then continue to remain “on” to expose the last-deposited layer of modeling material as well. This type of UV exposure is considered to be “indirect”. The UV light sources could be placed, for example, at the corners of the build chamber.

Alternatively, in a second set of embodiments, the build chamber is flooded with UV light to illuminate the entire build platform. However, the UV light sources do not remain continuously “on”. Rather, they are turned on intermittently (“alternating”). Once a given layer is completely deposited, that newly-deposited layer is exposed to ultraviolet radiation for a given time period. The modeling material may still be molten during the UV exposure, or the modeling material may have solidified prior to the UV exposure. It is contemplated that this exposure will induce crosslinking between the two layers, improving adhesion between them. Due to the thinness of the newly-deposited layer, the UV light can completely penetrate, inducing crosslinking along the complete contact surface area between the two adjacent layers. The UV light sources are then turned “off” while the deposition of the next layer occurs. It is contemplated that additional off/on patterns could perform the same function. For example, every other layer may be exposed to UV light, or some other pattern could be followed.

In a third set of embodiments, directed UV light sources are aimed at a specific location, more particularly on or around the deposition location of the nozzle/orifice of the extrusion head, so that the molten modeling material being extruded is continuously exposed to the UV radiation (i.e. the newly-deposited modeling material) as the modeling material is being deposited. Put another way, a specific portion of the modeling material is being exposed to UV radiation during deposition, i.e. is being cured during the deposition or after deposition. Here, rather than the indirect UV exposure of all deposited layers previously described in the first set of embodiments, only the modeling material currently being deposited and the portion of the layer underneath it are exposed to UV radiation (“focus”). Using these techniques to provide UV exposure can provide crosslinking not only on exterior surfaces of the article, but also along the complete contact surface area between two adjacent layers. This also ensures UV exposure of all modeling material that is deposited, with reduced concern that the final shape of the article will create “shadows” where some portions of the article prevent other portions of the article from being exposed to UV radiation. This technique also reduces differences in the amount of UV exposure between the different layers. It is contemplated that in this third set of embodiments, the UV light sources remain continuously “on” during the deposition of the modeling material until the article is completely built up. This can be accomplished by providing UV light sources on the extrusion head around the nozzle/orifice aimed at the deposition location. It is also contemplated that the “focused” light sources could also be turned on intermittently as well. Alternatively, an “exposure head” could be provided separately from the extrusion head. Only UV light sources would be present on the exposure head. The exposure head would follow the extrusion head, either on the same or a different gantry.

After the article is completely built-up, it is contemplated that a final exposure of the article to UV radiation could be used to increase crosslinks between the layers of the final molded article (“post-cure”). Alternatively, rather than exposing the various layers during their deposition, the final article could be exposed to UV radiation to induce crosslinking upon the surface of the final article. This final exposure may be at the same effective dosage as previously described.

The resulting article is expected to have a higher tensile modulus and flexural modulus than would otherwise be achieved by ME/AM processes, due to the additional adhesion between layers that results from the crosslinking. Similarly, it is expected that the resulting article will have a storage modulus of about 400 MPa to about 1,600 MPa as measured by ASTM D5023-07, as described above with respect to the cross-linkable polycarbonate resin being used as the modeling material.

The amount of crosslinking and the crosslinking density could be tuned by varying the type and amount of benzophenone present in the cross-linkable polycarbonate resin, the presence of certain chemical structures that increase the crosslinking rate, the type of UV light source used, and the exposure time of the deposited layers to the UV light. Improved chemical resistance and flame retardance is expected therefrom. This could allow parts made from the ME/AM process to be used in applications that were previously not possible for polycarbonate. The improvement in chemical resistance could also reduce or prevent chemical attack during the removal of any support material (which often requires immersion of the printed article in sodium hydroxide). This would also permit crystalline polycarbonates to be used in ME/AM processes, which is currently difficult due to the high coefficient of thermal expansion (CTE) possessed by such materials. The aesthetics of the final printed article may also be improved, because the striations between layers might be reduced due to the bonding of layers through cross-linking.

The following examples are provided to illustrate the polymers, compositions/blends, articles, and processes of the present disclosure. The examples are merely illustrative and are not intended to limit the disclosure to the materials, conditions, or process parameters set forth therein.

### EXAMPLES

Table A is a summary of the various components used in the following Examples.

TABLE A

| | | Trade |
|---|---|---|
| Component | Description | name |
| XPC - 1 | crosslinkable polycarbonate containing 10 | |
| | mol % 4,4′-dihydroxybenzophenone, | |
| | remainder bisphenol-A, p-cumylphenol | |
| | endcaps, Mw~22,000 | |
| XPC - 2 | crosslinkable polycarbonate containing 4 | |
| | mol % 4-hydroxybenzophenone, remainder | |
| | bisphenol-A, Mw~21,000 | |
| LF-PC | Bisphenol-A homopolymer with Mw~31,000 | |
| Rimar Salt | Potassium perfluorobutanesulfonate | Lanxess |
| Phosphite | Tris (2,4-di-tert-butylphenyl) phosphite | Irgaphos |
| | | 168 |

### Examples A1 and A2: Flood Cure

A Polar 3D fused filament deposition based (FDM) printer which used 1.75 mm diameter filament was used for these two examples. The Polar 3D machine was paired with a LED light source. The light source was a 365 nm UV LED light source (CS2010 controller with 365 nm peak LED source, Thor Labs). The LED source is rated to an intensity of 25 mW/cm² UVA at 20 mm without focusing optics.

For Examples A1 and A2, the LED was positioned 60 mm from the nozzle of the Polar 3D printer. This created a circular UV exposure area of 75 mm diameter on the FDM build platform, except for the area blocked by the printer head. Examples A1 and A2 were formed using “flood” curing, where the part was under constant UV exposure, the UV exposed area was significantly larger than the part dimensions, and the part received UV exposure throughout the printing process.

The filament had a composition of 25 wt % XPC-1, 74.94 wt % LF-PC, and 0.06 wt % phosphite. For Examples A1 and A2, 25 mm×25 mm×1.5 mm (L×W×H) plaques were printed. The article received 0.07 J/cm² of UVA irradiation per layer that was formed. Melted filament was deposited and printed in lines at 45° angle to the length direction, with a 90° rotation between each layer. Polar 3D samples were printed at 265° C. nozzle temperature with no temperature control on the build plate surface. Again, the UV light was on continuously through the printing process. The filament was initially optically clear, and printed parts were translucent and slightly yellow due to the crosslinking reaction. Control samples were visually similar but with no visible yellowing.

### Examples A3 and A4: “Focused” Cure

Next, the Polar 3D printer was modified so that the LED setup irradiated the stage in a focused manner with a collimating lens (CS20A2, collimated to 150 mW/cm² UVA, Thor Labs). The lens attached to the LED assembly was pointed at the nozzle tip from a distance of 25 mm. This setup was defined as “focused” because only the portion of the sample near the nozzle was irradiated. At times, the remainder of the part being printed was out of the UV light source.

For examples A3 and A4, 125 mm×13 mm×1.5 mm (L×W×H) bars were printed. Melted filament was deposited and printed in lines perpendicular to the 125 mm length, and each layer was deposited on top of the previous layer with no pattern re-orientation. These bars were printed at 265° C. nozzle temperature with no temperature control on the build plate surface. The UV light was on continuously through the printing process, but again only regions near the printer head were exposed to UV light. The UV light area was larger than the filament printing thickness, so samples were repeatedly exposed to UV irradiation. The total amount varied dependent on location. Dose per layer ranged from 0.05 J/cm² to 0.15 J/cm² of UVA irradiation. The filament was initially optically clear, and printed parts were translucent and slightly yellow due to the crosslinking reaction. Control samples were visually similar but with no visible yellowing. Injection molded parts were also produced from the same material in the same dimensions using injection molded UL flame bar tooling. Finally, a part was printed with no exposure, to serve as a control (Con1).

In Table 1, the Examples were measured for molecular weight increase compared to the control (Con1). Samples were also dissolved in methylene chloride. If material was sufficiently crosslinked by the UV exposure, an insoluble network would form and swell in methylene chloride. This insoluble network (or gel) would remain intact.

TABLE 1

| | Ex. A1 | Ex. A2 | Ex. A3 | Ex. A4 | Con1 |
|---|---|---|---|---|---|
| UVA LED Power | 100% | 100% | 50% | 100% | 0% |
| LED Configuration | Flood | Flood | Focused | Focused | N/A |
| Molecular Weight (Mw) | 28819 | 28805 | 28354 | 29599 | 26822 |
| (g/mol) | | | | | |
| Molecular Weight (Mn) | 11936 | 11967 | 11570 | 11822 | 10878 |
| (g/mol) | | | | | |
| Delta Mw (vs. Con1, g/mol) | 1997 | 1983 | 1532 | 2777 | — |
| Insoluble Polymer | Y | Y | Y | Y | N |

As seen in Table 1, with UV exposure, the molecular weight increased in all samples compared to control Con1. In addition, the sample parts showed an insoluble material upon dissolution, indicating that crosslinking has occurred.

Next, for Ex. A4 and control Con1, ten bars were printed in each condition and tested using dynamic mechanical analysis. These parts were compared against an injection molded part (IM1) of equivalent composition. The injection molded part was a standard UL V0 flame bar of 1.5 mm thickness (125 mm×13 mm×1.5 mm). The average storage modulus and Tg are reported in Table 2.

TABLE 2

| | Ex. A4 | Con1 | IM1 |
|---|---|---|---|
| Method | FDM | FDM | Injection |
| UVA LED Power | 100% | 0% | N/A |
| Storage Modulus | 574 | 465 | 1536 |
| (MPa, 40° C.) | | | |
| Tg (° C., by tan delta) | 151 | 151 | 151 |

As seen in Table 2, the bars which were UV exposed (A4) show a higher storage modulus compared to the unexposed control samples (Con1) printed under the same conditions and design. These values are significantly lower than injection molded parts (IM1), which was expected. The difference between samples A4 and Con1 may be a result of increased cohesion due to the crosslinking reaction occurring at the interfaces of the printed filament lines.

### Examples B1-B3: Alternating Samples

The light source was the same 365 nm UV LED light source with collimating lens as described above for Examples A3-A4. For Examples B1 to B3, 50 mm×13 mm×2 mm (L×W×H) bars were printed. Melted filament was deposited and printed in lines at a 45° angle to the length direction, with a 90° rotation between each layer. Polar 3D samples were printed at 265° C. nozzle temperature with no temperature control on the build plate surface. The UV light area was larger than the filament printing thickness, so samples were repeatedly exposed to UV irradiation. The total amount varied dependent on location. Dose per layer ranged from 0.025 J/cm² to 0.2 J/cm² of UVA irradiation. The filament was initially optically clear, and printed parts were translucent and slightly yellow due to the crosslinking reaction. Control samples (Con2) were visually similar but with no visible yellowing.

The UV light was varied as each layer was printed. For controlled UV exposure, three cases were evaluated. If the first layer deposited is considered layer 1 and the successive layer is considered layer 2, the first case (B1) had UV exposure during odd layers only. During even layers, the LED was shut off and no UV exposure reached the printed sample. The second case (B2) had UV exposure on every even layer, with no UV exposure for odd layers. The third case (B3) had UV exposure during every layer during printing. The printed filament was optically clear, but printed parts were translucent and slightly yellow due to the crosslinking reaction. Control samples (Con2) were visually similar but with significantly less yellowing. The results are shown in Table 3.

TABLE 3

| UVA LED Power | Con2 | Ex. B1 | Ex. B2 | Ex. B3 |
|---|---|---|---|---|
| Odd Layer Irradiation | 0% | 100% | 0% | 100% |
| Even Layer Irradiation | 0% | 0% | 100% | 100% |
| Molecular Weight (Mw) (g/mol) | 26666 | 29443 | 29373 | 30732 |
| Molecular Weight (Mn) (g/mol) | 11051 | 12161 | 12206 | 12298 |
| Delta Mw (g/mol) | — | 2777 | 2707 | 4066 |
| Insoluble Polymer | N | Y | Y | Y |

Compared to the control sample with no UV irradiation (Con2), the three UV irradiated examples exhibited fragments of insoluble polymer after dissolution in methylene chloride. All exposed samples had an increase in the overall molecular weight of the sample after exposure. Both alternating cases had similar results in molecular weight increase, indicative of similar crosslinking rates to UV exposure. The largest increase in molecular weight was with the sample where the LED was continuously on, which was expected.

### Examples C1-C3

A UV LED light source (LX400 controller with two 365 nm peak LED Max heads and 8 mm focusing lens, Excelitas) was integrated into a MakerBot® Replicator 2× fused deposition modeling system. Two LED heads were attached and positioned to point at the dispensing nozzle of the filament printer. The intensity of the light below the nozzle was measured using an UV radiometer (UV PowerPuck II, EIT) in the UVA band, with the nozzle 15 mm above the build plate surface.

In this configuration, the LED intensity could be varied from 15% to 100% of the maximum power with one or two LED active at any time. The UVA intensity could be varied from 13 mW/cm² to 175 mW/cm² based on the number of LEDs active and the relative power settings of each LED. In all examples, both LEDs were set to the same power conditions and turned on or off simultaneously.

The filament had a composition of 99.86 wt % XPC-2, 0.08 wt % Rimar salt, and 0.06 wt % phosphite (Con3). The filament was extruded with a 1.75 mm target diameter. Five bars of dimensions 76.2×10.2×6.58 mm (3×0.4×0.26 inch) were printed using material extrusion on a Makerbot printer. The bars were printed with a nozzle temperature of 300° C. Tested intensities were 0% (C1), 15% (C2), and 30% (C3) of maximum power, which correspond to 26 mW/cm² and 52 mW/cm². The UV light area was larger than the filament printing thickness, so samples were repeatedly exposed to UV irradiation. The total amount varied dependent on location. Dose per layer ranged from 0.025 J/cm² to 0.2 J/cm² of UVA irradiation (C2) and 0.05 J/cm² to 0.4 J/cm² of UVA irradiation (C3). Short beam shear test (ASTM D 2344-Rev. 2013) was conducted on the printed bars.

The results are shown in Table 4. All parts failed to break under these printing conditions, with statistically equivalent modulus and flexural stress at 5% values. The molecular weight significantly increased when exposed to UVA at either the 15% or 30% LED power settings. In addition, insoluble polymer was present when exposed to UV crosslinking.

TABLE 4

| | Con3 | Ex. C1 | Ex. C2 | Ex. C3 |
|---|---|---|---|---|
| Material | Pellets | HBP | HBP | HBP |
| UVA LED Power | — | 0% | 15% | 30% |
| Flexural Modulus (MPa) | — | 1470 | 1430 | 1460 |
| Flexural Stress at 5% Strain (MPa) | — | 67 | 66 | 66 |
| Molecular Weight (Mw) (g/mol) | 20737 | 20811 | 22299 | 24037 |
| Molecular Weight (Mn) (g/mol) | 5170 | 5360 | 5489 | 5646 |
| Delta Mw (g/mol) | — | 74 | 1562 | 3300 |
| Insoluble Polymer (wt %) | N | N | N | Y |

### Examples D1-D3: Post Cure

Three samples were made under previously tested conditions. Sample D1 was taken from Sample A4. Sample D2 was taken from Con1. Sample D3 was taken from Sample C1. These already-printed samples were placed in a separate UV chamber and irradiated with filtered UV light provided by a Loctite Zeta 7411-S system, which used a 400W metal halide arc lamp and behaved like a D-bulb electrodeless bulb in spectral output with a 280-nm cut-on wavelength filter. The samples were exposed to both sides with 19.2 J/cm² of UVA as measured by a UV radiometer (UV PowerPuck II, EIT) in the UVA band. Parts were then measured for molecular weight to determine if crosslinking still occurred even after additional exposure. The results are shown in Table 5.

TABLE 5

| | Ex. D1 | Ex. D2 | Ex. D3 |
|---|---|---|---|
| Example | A4 | Con1 | C1 |
| Exposed During Printing | Y | N | N |

Post Printing Exposure

| | | | |
|---|---|---|---|
| UVA Dose, Side 1 (J/cm²) | 19.2 | 19.2 | 19.2 |
| UVA Dose, Side 2 (J/cm²) | 19.2 | 19.2 | 19.2 |
| Molecular Weight (Mw) (g/mol) | 51733 | 51284 | 36953 |
| Molecular Weight (Mn) (g/mol) | 12925 | 12788 | 12622 |
| Insoluble Polymer | Y | Y | Y |

As seen in Example D1, a previously exposed sample during printing could be exposed to further the crosslinking reaction. Similarly, as seen in Examples D2 and D3, a printed sample unexposed to UV irradiation could be exposed to UV irradiation after the printing is complete to crosslink the surface of the 3D printed article.

Set forth below are some embodiments of the methods disclosed herein.

### Embodiment 1

A method of making an article, comprising: depositing one or more layers of extruded material in molten form in a preset pattern, wherein at least one layer is formed from a modeling material; and exposing the modeling material to an effective dosage of ultraviolet radiation to cause cross-linking in the article; wherein the modeling material is a polymeric composition that comprises a cross-linkable polycarbonate resin containing a photoactive group derived from a benzophenone.

### Embodiment 2

The method of Embodiment 1, wherein the modeling material is continuously exposed to the ultraviolet radiation during the deposition thereof in molten form.

### Embodiment 3

The method of Embodiment 2, wherein the deposition of the modeling material occurs in a chamber that is flooded with the ultraviolet radiation, such that the modeling material is continuously exposed to the ultraviolet radiation during deposition of each layer.

### Embodiment 4

The method of Embodiment 2, wherein a directed ultraviolet light source is used to expose a specific portion of the modeling material in molten form to ultraviolet radiation during the deposition thereof.

### Embodiment 5

The method of Embodiment 1, wherein a given layer of the modeling material is exposed to the ultraviolet radiation after the deposition of the given layer is complete.

### Embodiment 6

The method of Embodiment 5, wherein the modeling material of the layer is still in molten form during exposure to the ultraviolet radiation, or is solidified prior to exposure to the ultraviolet radiation.

### Embodiment 7

The method of Embodiment 1, wherein the layers of the modeling material are exposed to the ultraviolet radiation in a specified pattern.

### Embodiment 8

The method of any one of Embodiments 1-7, wherein the modeling material is exposed to the ultraviolet radiation after the deposition of the one or more layers is complete.

### Embodiment 9

The method of Embodiment 1, wherein the benzophenone from which the photoactive group is derived is a monohydroxybenzophenone.

### Embodiment 10

The method of Embodiment 9, wherein the cross-linkable polycarbonate resin is formed from a reaction comprising: the monohydroxybenzophenone; a diol chain extender; and a first linker moiety comprising a plurality of linking groups, wherein each linking group can react with the hydroxyl groups of the monohydroxybenzophenone and the diol chain extender.

### Embodiment 11

The method of Embodiment 10, wherein the cross-linkable polycarbonate resin contains from about 0.5 mol % to about 5 mol % of endcap groups derived from the monohydroxybenzophenone.

### Embodiment 12

The method of Embodiment 1, wherein the benzophenone from which the photoactive group is derived is a dihydroxybenzophenone.

### Embodiment 13

The method of Embodiment 12, wherein the cross-linkable polycarbonate resin is formed from a reaction comprising: the dihydroxybenzophenone; a diol chain extender; a first linker moiety comprising a plurality of linking groups, wherein each linking group can react with the hydroxyl groups of the dihydroxybenzophenone and the diol chain extender; and an end-capping agent.

### Embodiment 14

The method of Embodiment 13, wherein the dihydroxybenzophenone is 4,4′-dihydroxybenzophenone; the diol chain extender is bisphenol-A; and the first linker moiety is phosgene.

### Embodiment 15

The method of Embodiment 12, wherein the cross-linkable polycarbonate resin contains from about 0.5 mol % to about 50 mol % of repeating units derived from the dihydroxybenzophenone.

### Embodiment 16

The method of any one of Embodiments 1-15, wherein the modeling material is exposed to from about 0.025 J/cm² to about 21 J/cm² of UVA radiation, or wherein the modeling material is exposed to ultraviolet radiation having a wavelength between 280 nm and 380 nm.

### Embodiment 17

The method of any one of Embodiments 1-16, wherein at least one layer is formed from an extruded material that is different from the modeling material, or wherein each layer is formed from the modeling material.

### Embodiment 18

The article formed by the method of any one of Embodiments 1-17.

### Embodiment 19

The article of Embodiment 18, wherein the article has a storage modulus of about 400 MPa to about 1,600 MPa as measured by ASTM D5023-2007.

### Embodiment 20

method of making an article, comprising: depositing one or more layers of extruded material in molten form in a preset pattern, wherein at least one layer is formed from a modeling material; and exposing the modeling material to an effective dosage of ultraviolet radiation to cause cross-linking in the article; wherein the modeling material is a polymeric composition that comprises a cross-linkable polycarbonate resin containing a photoactive group.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A method of making an article, comprising:
depositing one or more layers of extruded material in molten form in a preset pattern, wherein at least one layer is formed from a modeling material; and
exposing the modeling material to an effective dosage of ultraviolet radiation to cause cross-linking in the article;
wherein the modeling material is a polymeric composition that comprises a cross-linkable polycarbonate resin containing a photoactive group derived from a benzophenone.

2. The method of claim 1, wherein the modeling material is continuously exposed to the ultraviolet radiation during the deposition thereof in molten form.

3. The method of claim 2, wherein the deposition of the modeling material occurs in a chamber that is flooded with the ultraviolet radiation, such that the modeling material is continuously exposed to the ultraviolet radiation during deposition of each layer.

4. The method of claim 2, wherein a directed ultraviolet light source is used to expose a specific portion of the modeling material in molten form to ultraviolet radiation during the deposition thereof.

5. The method of claim 1, wherein a given layer of the modeling material is exposed to the ultraviolet radiation after the deposition of the given layer is complete.

6. The method of claim 5, wherein the modeling material of the layer is still in molten form during exposure to the ultraviolet radiation, or is solidified prior to exposure to the ultraviolet radiation.

7. The method of claim 1, wherein the layers of the modeling material are exposed to the ultraviolet radiation in a specified pattern.

8. The method of claim 1, wherein the modeling material is exposed to the ultraviolet radiation after the deposition of the one or more layers is complete.

9. The method of claim 1, wherein the benzophenone from which the photoactive group is derived is a monohydroxybenzophenone.

10. The method of claim 9, wherein the cross-linkable polycarbonate resin is formed from a reaction comprising:
the monohydroxybenzophenone;
a diol chain extender; and
a first linker moiety comprising a plurality of linking groups, wherein each linking group can react with the hydroxyl groups of the monohydroxybenzophenone and the diol chain extender.

11. The method of claim 10, wherein the cross-linkable polycarbonate resin contains from about 0.5 mol % to about 5 mol % of endcap groups derived from the monohydroxybenzophenone.

12. The method of claim 1, wherein the benzophenone from which the photoactive group is derived is a dihydroxybenzophenone.

13. The method of claim 12, wherein the cross-linkable polycarbonate resin is formed from a reaction comprising:
the dihydroxybenzophenone;
a diol chain extender;
a first linker moiety comprising a plurality of linking groups, wherein each linking group can react with the hydroxyl groups of the dihydroxybenzophenone and the diol chain extender; and
an end-capping agent.

14. The method of claim 13, wherein the dihydroxybenzophenone is 4,4′-dihydroxybenzophenone; the diol chain extender is bisphenol-A; and the first linker moiety is phosgene.

15. The method of claim 12, wherein the cross-linkable polycarbonate resin contains from about 0.5 mol % to about 50 mol % of repeating units derived from the dihydroxybenzophenone.

16. The method of claim 1, wherein the modeling material is exposed to from about 0.025 J/cm² to about 21 J/cm² of UVA radiation, or wherein the modeling material is exposed to ultraviolet radiation having a wavelength between 280 nm and 380 nm.

17. The method of claim 1, wherein at least one layer is formed from an extruded material that is different from the modeling material, or wherein each layer is formed from the modeling material.

18. The article formed by the method of claim 1.

19. The article of claim 18, wherein the article has a storage modulus of about 400 MPa to about 1,600 MPa as measured by ASTM D5023-2007.

20. A method of making an article, comprising:
depositing one or more layers of extruded material in molten form in a preset pattern, wherein at least one layer is formed from a modeling material; and
exposing the modeling material to an effective dosage of ultraviolet radiation to cause cross-linking in the article;
wherein the modeling material is a polymeric composition that comprises a cross-linkable polycarbonate resin containing a photoactive group.
